(19) United States
(12) Patent Application Publication
(10) Pub. No.: US 2026/0087007 A1
(43) Pub. Date: Mar. 26, 2026

(54) PROCESSOR CIRCUITRY FOR PERFORMING A CACHE SEARCH BASED ON AN EXECUTION DOMAIN IDENTIFIER

(71) Applicant: Intel Corporation, Santa Clara, CA (US)

(72) Inventors: Thomas Unterluggauer, Villach (AT); Fangfei Liu, Hillsboro, OR (US); Scott Constable, Portland, OR (US); Carlos Rozas, Portland, OR (US); Gilles Pokam, Livermore, CA (US); Raghunandan Makaram, Northborough, MA (US)

(73) Assignee: Intel Corporation, Santa Clara, CA (US)

(21) Appl. No.: 18/898,385

(22) Filed: Sep. 26, 2024

(51) Int. Cl. G06F 16/2453

(52) U.S. Cl. CPC G06F 16/24539

(57) ABSTRACT

Techniques and mechanisms for a cache search to be performed based on a search parameter which identifies an execution domain. In an embodiment, a processor core comprises circuitry to facilitate the servicing of a memory access request by performing a cache search according to a domain-specific search mode. A criteria of the domain-specific search mode includes both an address parameter and a domain identifier parameter. The circuitry detects a mismatch condition for a given cache line where it is determined that—notwithstanding a correspondence between the address parameter and an address value for the cache line—the domain identifier parameter does not correspond to a domain identifier value which corresponds to that given cache line. In another embodiment, the processor core is operable to selectively search the cache according to either one of a domain-specific search mode or a domain-generic search mode.

### BACKGROUND

### 1. Technical Field

This disclosure generally relates to processor circuitry and more particularly, but not exclusively, to circuit resources which facilitate secure access to a cache of a processor unit.

### 2. Background Art

Virtualization enables a single host machine with hardware and software support for virtualization to present an abstraction of the host, such that the underlying hardware of the host machine appears as one or more independently operating virtual machines. Each virtual machine may therefore function as a self-contained platform. Often, virtualization technology is used to allow multiple guest operating systems and/or other guest software to coexist and execute apparently simultaneously and apparently independently on multiple virtual machines while actually physically executing on the same hardware platform. A virtual machine may mimic the hardware of the host machine or alternatively present a different hardware abstraction altogether.

Virtualization systems typically include a virtual machine monitor (VMM) which controls the host machine. The VMM provides guest software operating in a virtual machine with a set of resources (e.g., processors, memory, IO devices). The VMM may map some or all of the components of a physical host machine into the virtual machine, and may create fully virtual components, emulated in software in the VMM, which are included in the virtual machine (e.g., virtual IO devices). The VMM may thus be said to provide a “virtual bare machine” interface to guest software. The VMM uses facilities in a hardware virtualization architecture to provide services to a virtual machine and to provide protection from and between multiple virtual machines executing on the host machine.

As guest software executes in a virtual machine, certain instructions executed by the guest software (e.g., instructions accessing peripheral devices) would normally directly access hardware, were the guest software executing directly on a hardware platform. In a virtualization system supported by a VMM, these instructions may cause a transition to the VMM, referred to herein as a virtual machine exit. The VMM handles these instructions in software in a manner suitable for the host machine hardware and host machine peripheral devices consistent with the virtual machines on which the guest software is executing. Similarly, certain interrupts and exceptions generated in the host machine may need to be intercepted and managed by the VMM or adapted for the guest software by the VMM before being passed on to the guest software for servicing. The VMM then transitions control to the guest software and the virtual machine resumes operation. The transition from the VMM to the guest software is referred to herein as a virtual machine entry.

As is well known, a process executing on a machine on most operating systems may use a linear address space, which is an abstraction of the underlying physical memory system. As is known in the art, the term linear when used in the context of memory management e.g., “linear address,” “linear address space,” or “linear memory address” refers to the well-known technique of a processor-based system, generally in conjunction with an operating system, presenting an abstraction of underlying physical memory to a process executing on a processor-based system. For example, a process may access a contiguous and linearized address space abstraction which is mapped to non-linear and non-contiguous physical memory by the underlying operating system. It should be noted that the term “virtual memory” is often used in the art to denote a linear address space as described above. The term “virtual memory” is not used hereinafter to avoid confusion with “virtual” as used in the context of machine virtualization.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a device to provide a cache search functionality according to an embodiment.

FIG. 2 shows a flow diagram illustrating features of a method to search a cache based on an execution domain identifier according to an embodiment.

FIG. 3A shows a block diagram illustrating features of a system for accessing a cache according to a domain-specific search criteria according to an embodiment.

FIG. 3B shows a block diagram illustrating features of a processor core for supporting multiple cache search modes including a domain-specific search mode according to an embodiment.

FIG. 4 shows a flow diagram illustrating features of a method for selectively performing a cache search according to any of multiple cache search modes including a domain-specific search mode according to an embodiment.

FIG. 5A shows a block diagram illustrating address translation with an extended page table which facilitates cache search functionality according to an embodiment.

FIG. 5B shows a block diagram illustrating use of extended page tables to translate a guest physical address to a host physical address according to an embodiment.

FIG. 6 shows a flow diagram illustrating features of a method for performing cache searches each according to a respective one of various cache search modes according to an embodiment.

FIG. 7 shows a block diagram illustrating features of a processor for implementing any of various cache search criteria according to an embodiment.

FIG. 8 shows a data diagram illustrating operation for providing a copy-on-write based on a cache search according to an embodiment.

FIG. 9 illustrates an exemplary system.

FIG. 10 illustrates a block diagram of an example processor that may have more than one core and an integrated memory controller.

FIG. 11A is a block diagram illustrating both an exemplary in-order pipeline and an exemplary register renaming, out-of-order issue/execution pipeline according to examples.

FIG. 11B is a block diagram illustrating both an exemplary example of an in-order architecture core and an exemplary register renaming, out-of-order issue/execution architecture core to be included in a processor according to examples.

FIG. 12 illustrates examples of execution unit(s) circuitry.

FIG. 13 is a block diagram of a register architecture according to some examples.

FIG. 14 illustrates examples of a graphics multiprocessor in which the graphics multiprocessor couples with the pipeline manager of the processing cluster.

FIGS. 15A-15B illustrate additional graphics multiprocessors, according to examples.

FIG. 16 illustrates thread execution logic including an array of processing elements employed in a graphics processor core according to examples described herein.

### DETAILED DESCRIPTION

Embodiments discussed herein variously provide techniques and mechanisms for a cache search to be performed based on a search parameter which identifies an execution domain. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which supports domain-specific cache search functionality.

Processor caches are often a vital component of computing architectures, as they bridge a performance gap between a processor unit and a system memory. In recent years, caches have increasingly been a source of information leakage that can be exploited in so-called “side-channel” attacks. These attacks allow malicious agents to infer sensitive data, such as cryptographic keys, by analyzing the cache-induced timing differences of memory accesses. For instance, cache-based side-channel attacks have been used to break implementations of the Advanced Encryption Standard (AES) and Rivest-Shamir-Adleman (RSA) cryptography, to bypass address space layout randomization (ASLR), and/or to facilitate leakage of sensitive data in speculative execution attacks like Spectre and Meltdown.

One particularly powerful class of cache side channel attacks is based on shared memory. Specifically, sharing memory between distrusting domains—such as between virtual machines (VMs) executing in said domains—can enable attackers to access low-noise indicia about (for example) memory access patterns in code shared via VM images or shared libraries. Such indicia is available, for example, by analysis of cache hit/miss information on cache lines shared through the shared memory. To mitigate such risks, cloud service customers have increasingly tended to disable memory sharing between VM instances. However, even though VM base images in a large cloud environment are often very uniform, such VMs often have their own respective image copies in dynamic random access memory (DRAM) to prevent shared-memory based side channels, which results in significant memory consumption.

Some embodiments variously mitigate the sort of memory overhead which, for example, is often due at least in part to the storing of duplicative VM images in memory. For example, different embodiments variously enable a caching of duplicative lines in a cache—e.g., including two or more lines each for a different respective domain. The possibility of two or more cache lines being duplicative (e.g., where different lines each cache a respective version of information in the same memory location) mitigates the ability of malicious agents to infer memory access patterns on shared memory cache lines. This risk mitigation facilitates a secure and efficient utilization of memory resources wherein multiple domains share a single version of information—e.g., including a shared virtual machine code image—which is stored in a DRAM or other suitable memory.

In various embodiments, a given domain is assigned a unique identifier which is to be available as a basis for one or more cache lines to be variously cached, searched and/or otherwise accessed on behalf of a process which executes with said domain. Accordingly, some embodiments facilitate a secure sharing of a memory resource (e.g., a page of memory) while, for example, two or more cache lines concurrently provide, for different domains, respective versions—for example, respective copies—of information in the same memory location. Instead of implicitly encoding domain information for aliased cache lines in the partition, some embodiments tag cache lines with domain identifiers to facilitate (for example) secure and dynamic resource sharing.

As used herein, “execution domain” (or, for brevity, simply “domain”) refers to a set of resources—e.g., comprising, hardware, firmware, executing software and/or configuration state—which are allocated to support the execution of one or more software processes. In various embodiments, such a set of resources includes, but is not limited to, some or all of a set of cryptographic keys (and/or other suitable cryptographic information), a private region of a memory, processor cycles which are to support a particular execution context, or the like. For example, cryptographic and/or other protections enable secure execution of a (VM) inside a trust domain (TD), wherein the memory and logical processor execution states of the VM are not accessible to a virtual machine monitor (VMM) or other such hypervisor process. In one example embodiment, an execution domain operates, or is otherwise provided, with any of various TD mechanisms, such as those provided with an instruction set architecture (ISA) which supports Trust Domain Extensions (TDX), secure arbitration mode (SEAM) functionality, and/or the like.

In an illustrative scenario according to one embodiment, multiple execution domains variously facilitate the execution of different respective software processes at the same processor—e.g., wherein a set of resources (or “resource set”) of one such execution domain is distinct from, and exclusive of, the resource set of another such execution domain. For example, a first software process executed with a first resource set of a first execution domain is prevented from accessing a second resource set of a second execution domain.

As used herein, “unique domain identifier” refers to a value which is allocated to be representative of a given one (and only one) execution domain. In some embodiments, various unique domain identifiers are each representative of a different respective one of multiple execution domains. In various embodiments, the instantiation, allocation and/or other generation to an execution domain includes or otherwise results in an allocation of a corresponding unique identifier. Alternatively or in addition, the termination of an execution domain includes or otherwise results in a deallocation of such a corresponding unique identifier.

A unique domain identifier is used, in some embodiments, to indicate that the corresponding execution domain is authorized to have at least some access to a given resource, such as a particular page in a memory. In this particular context, a unique domain identifier is to be distinguished from another type of identifier (referred to herein as a “default domain identifier”, or simply “default identifier”) which is to be representative of no particular one execution domain. For example, various embodiments use a default domain identifier to indicate that access to a given resource is not limited to any particular execution domain(s). Unless otherwise indicated, “domain identifier” (or “XDID”) refers herein to a unique domain identifier, rather than a default identifier.

In some embodiments, a unique domain identifier is a resource set which support an execution of a software process, where the resource set is to be distinguished from the executing software process itself. Alternatively or in addition, a unique domain identifier includes or is otherwise based on an identifier of a VM (a “VMID” herein) which is currently allocated to execute with the resource set of the corresponding execution domain.

Some embodiments facilitate a secure sharing of a memory resource (e.g., a page) between distrusting execution domains by enabling distinct cache line copies of information in a memory location which is shared by said execution domains. In various embodiments, two or more execution domains are identified each by a different respective XDID. In one such embodiment, a given execution domain is able to access a cache line only where the cache line is tagged, or otherwise associated, with that execution domain's own XDID. For example, requests to access a shared memory page are serviced at least in part by searching a cache based on an execution domain identifier. In one such embodiment, requests to access a non-shared memory page are serviced at least in part by performing a cache search which is agnostic as to (independent of) any unique execution domain identifier.

For example, some embodiments variously enable the use of a unique domain identifier as a cache search parameter—e.g., as a basis upon which a given line of a cache is to be identified as being “hit” by a cache search or (alternatively) as being “missed” by said cache search. In this particular context, “cache hit”, “hit”, and similar terms variously refer herein to the detection of a match condition upon an evaluation of metadata which corresponds to the cache line in question. By contrast, “cache miss”, “miss”, and similar terms variously refer herein to the detection of a mismatch condition upon such metadata evaluation.

In various embodiments, a cache search is performed based on criteria (“cache search criteria” or, for brevity, “search criteria” herein) which include a domain identifier parameter and, for example, an address parameter. By way of illustration and not limitation, a memory access request is generated with an execution domain (e.g., by a VM or other process which executes with said domain), wherein the memory access request includes an address that corresponds to a targeted location in a memory. Some embodiments variously service such a memory access request by performing a search of at least a portion of a cache, wherein the address and a unique identifier of the execution domain are two parameters—e.g., an “address parameter” and “domain identifier parameter”—of such a search. For example, the address and a unique domain identifier provide one or more bases according to which metadata, for a given cache line, is to be evaluated as part of the cache search.

The term “domain-specific search mode” (or simply “domain-specific mode”) refers herein to a mode according to which at least a portion of a cache is to be searched, wherein a search criteria according to the mode comprises both an address parameter and a unique domain identifier parameter. By contrast, “domain-agnostic search mode” (or “domain-generic search mode”) refers herein to an alternative mode according to which at least a portion of a cache is to be searched, wherein a search criteria according to the alternative mode is independent of—e.g., omits—any unique domain identifier parameter. In this context, a domain-specific mode is a relatively constrained cache search mode, whereas a domain-agnostic mode is a relatively unconstrained cache search mode.

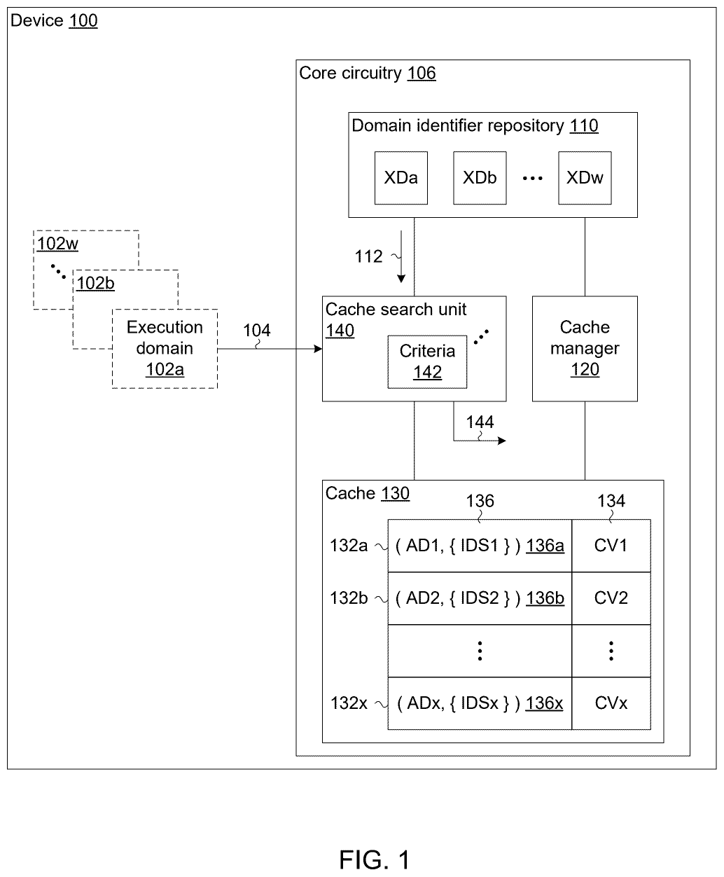

FIG. 1 shows a device 100 which provides a cache search functionality according to an embodiment. The device 100 illustrates features of one example embodiment wherein logic (e.g., comprising hardware, firmware and/or executing software) enables a search of a cache using criteria which includes, or is otherwise based on, both an address parameter and a domain identifier parameter.

As shown in FIG. 1, device 100 comprises core circuitry 106 which facilitates the servicing of a memory access request at least in part by searching a cache for a cached version (if any) of information targeted by the request. For example, device 100 comprises some or all of a processor—e.g., including a single core or a multi-core processing unit—such as any of various suitable central processing units (CPUs), graphics processing units (GPUs), micro-processing units (MPUs) or the like. In some example embodiments, device 100 is, or includes, one or more integrated circuit (IC) chips including (for example) any of various suitable system on chip (SoC) devices. In one such embodiment, device 100 is, or includes, a packaged device which comprises the one or more IC chips.

Core circuitry 106 comprises some or all of a processor core, wherein core circuitry 106 facilitates the execution of one or more software processes. In various embodiments, such one or more software processes include an operating system (OS) and one or more applications which are supported with the OS. In various embodiments, a processor core including core circuitry 106 supports the execution of a hypervisor process and one or more other processes which are managed by the hypervisor process—e.g., wherein the one or more other processes each to facilitate the availability of a respective logical machine. For example, core circuitry 106 facilitates execution of a virtual machine manager (VMM) and one or more virtual machines (VMs) which are managed by the VMM. In one such embodiment, some or all of the hypervisor and the one or more other processes variously execute each with a respective execution domain (e.g., including the illustrative execution domains 102a, 102b, . . . , 102w shown.

To facilitate cache search functionality according to some embodiments, core circuitry 106 comprises (or is coupled to operate with) some or all of a cache 130, a cache manager 120, and a cache search unit 140. Cache 130 illustrates any of various suitable processor caches—e.g., including a level 1 (L1) cache, a mid-level cache (MLC), a last level cache (LLC) or the like—which is subject to being searched in the servicing of a memory access request. By way of illustration and not limitation, such a memory access request includes any of various suitable read instructions, write instructions, cache flush instructions, or the like.

Cache 130 comprises multiple cache lines 132 (e.g., including the illustrative lines 132a, 132b, . . . , 132x) which are each indexed, tagged, and/or otherwise associated with respective metadata. For example, lines 132 each comprise a respective field 134 to provide a cached version of information (comprising instructions, data and/or the like) which is at a corresponding memory location. In some embodiments, lines 132 each further comprise, or are otherwise associated with, a respective one or more other fields (e.g., including the illustrative field 136 shown) which is to provide metadata for the cached information in the corresponding field 134.

By way of illustration and not limitation, line 132a comprises a cached version CV1 of information which is stored at a first location of a system memory (not shown) which device 100 includes or, alternatively, is to be coupled to. Line 132a further includes (or is otherwise associated with) metadata 136a which, for example, facilitates a searching for line 132a in cache 130. For example, one or more values of the metadata 136a include or are otherwise based on an address AD1 which corresponds to the first memory location. Alternatively or in addition, one or more values of the metadata 136a include or are otherwise based on an set IDS1 of a first one or more domain identifiers that, for example, each have authorization to access a memory page which includes the first memory location.

Similarly, line 132b comprises a cached version CV2 of information which is stored at a second location of the system memory. Line 132b further includes or is otherwise associated with metadata 136b which, for example, facilitates a searching for line 132b in cache 130. For example, one or more values of the metadata 136b include or are otherwise based on an address AD2 which corresponds to the second memory location. Alternatively or in addition, one or more values of the metadata 136b include or are otherwise based on an set IDS2 of a second one or more domain identifiers that, for example, each have authorization to access a memory page which includes the second memory location.

Similarly, line 132x comprises a cached version CVx of information which is stored at a third location of the system memory. Line 132x further includes or is otherwise associated with metadata 136x which, for example, facilitates a searching for line 132x in cache 130. For example, one or more values of the metadata 136x include or are otherwise based on an address ADx which corresponds to the third memory location. Alternatively or in addition, one or more values of the metadata 136x include or are otherwise based on an set IDSx of a third one or more domain identifiers that, for example, each have authorization to access a memory page which includes the third memory location.

In an embodiment, cache manager 120 provides functionality to associate various ones of lines 132 each with respective metadata that (for example) facilitates a later search of cache 130. For example, cache manager 120 provides to the respective field 134 of a given line 132 a cached version of information (such as that illustrated by CV1, C2 or CVx) that is at a corresponding memory location. Furthermore, cache manager 120 provides one or more metadata values to the respective field 136 of a given line 132. In some embodiments, operations of cache manager 120 are adapted from conventional cache management techniques, which are not detailed herein to avoid obscuring certain features of such embodiments.

In some embodiments, cache manager 120 facilitates domain-specific cache searches by variously providing the respective sets IDS1, IDS2, . . . , IDSx of one or more domain identifiers for the corresponding lines 132a, 132b, . . . , 132x. In various other embodiments, cache manager 120 instead provides such sets IDS1, IDS2, . . . , IDSx outside of lines 132—e.g., wherein one or more lookup tables and/or other suitable data structures (not shown) are further provided and or otherwise used by cache manager 120 to associate the sets IDS1, IDS2, . . . , IDSx with lines 132a, 132b, . . . , 132x, respectively.

Cache search unit 140 provides functionality to perform a search of cache 130 based on a memory access request, wherein the search is according to a search criteria 142. In various embodiments, criteria 142 includes, or is otherwise based on, both an address parameter and a domain identifier parameter. In one such embodiment, for a given memory access request, cache search unit 140 determines a value of an address parameter, as well as a value of a domain identifier parameter, to facilitate a search of at least a portion of cache 130. For example, the value of the address parameter is to be equal to, or otherwise based on, a first address which is specified by the memory access request in question—e.g., wherein the address parameter includes some or all of a second address which is determined based on a translation of the first address. Alternatively or in addition, the value of the domain identifier parameter is to be based on a unique identifier of the execution domain with which the memory access request was provided to core circuitry 106.

In some embodiments, a cache search includes, for a given line 132, evaluating metadata—which is included in, or otherwise corresponds to, that same line 132—to detect for the presence or absence of a match condition. The match condition incudes the value of the address parameter being equal (or otherwise corresponding) to the address which is indicated by metadata for the line 132 in question. In some embodiments, the match condition further incudes the value of the domain identifier parameter being equal (or otherwise corresponding) to a domain identifier indicated by metadata for the line 132 in question. Alternatively or in addition, such a cache search includes cache search unit 140 evaluating the metadata to detect for the absence or presence of a mismatch condition which, for example, includes either or each of a mismatch between the address parameter and the address in the memory access request, and a mismatch between the domain identifier parameter and the domain identifier for the corresponding execution domain.

By way of illustration and not limitation, a processor which includes core circuitry 106 facilitates the execution of one or more software processes each in a respective domain (such as a respective one of the illustrative execution domains 102a, 102b, . . . , 102w shown). In an illustrative scenario according to one embodiment, core circuitry 106 receives from a software process—which executes with execution domain 102a—a memory access request 104 which includes an address that corresponds to a targeted location in a memory (not shown). Cache search unit 140 performs a search of at least a portion of cache 130 as part of operations to service memory access request 104. By way of illustration and not limitation, cache search unit 140 includes or otherwise has access to a repository 110 of domain identifier information. In the example embodiment shown, such domain identifier information specifies or otherwise indicates that execution domains 102a, 102b, . . . , 102w are assigned unique domain identifiers XDa, XDb, . . . , XDw (respectively). In one such embodiment, cache search unit 140 accesses domain identifier repository 110 to retrieve information 112 specifying the identifier XDa of the execution domain 102a which corresponds to memory access request 104. Cache search unit 140 then participates in a servicing of memory access request 104 by searching cache 130 according to criteria 142—e.g., wherein an address parameter of the search is based on the address communicated in memory access request 104, and wherein a domain identifier parameter of the search is based on the identifier XDa for execution domain 102a.

Based on the search of cache 130 according to criteria 142, cache search unit 140 generates a signal 144 to facilitate the servicing of memory access request 104—e.g., wherein signal 144 indicates whether the search has resulted in a “hit” or a “miss” of cache 130 (due to, respectively, a detected match condition or a detected mismatch condition). In one such embodiment, signal 144 includes the cached information from a cache line for which a match condition was detected.

In an illustrative scenario according to one embodiment, such a cache search is performed while the value of the address parameter is the same as (or otherwise corresponds to) both the address AD1 indicated by metadata 136a of line 132a, and the address AD2 indicated by metadata 136b of line 132b. Furthermore, the cache search is performed while the set IDS1 indicated by metadata 136a of line 132a omits the unique domain identifier XDa, and while the set IDS2 indicated by metadata 136b of line 132b includes the identifier XDa.

In one such embodiment, the evaluation of metadata 136a results in the detection of a mismatch condition for line 132a, due to the omission of unique domain identifier XDa from the set IDS1—i.e., notwithstanding the fact that the address parameter corresponds to the address AD1. By contrast, the evaluation of metadata 136b results in the detection of a match condition for line 132b—i.e., due to the inclusion of unique domain identifier XDa in the set IDS2, in combination with the correspondence of address parameter with the address AD2 indicated by metadata 136b. In one such embodiment, signal 144 identifies the cached information CV2 of the line 132b which was hit by the cache search.

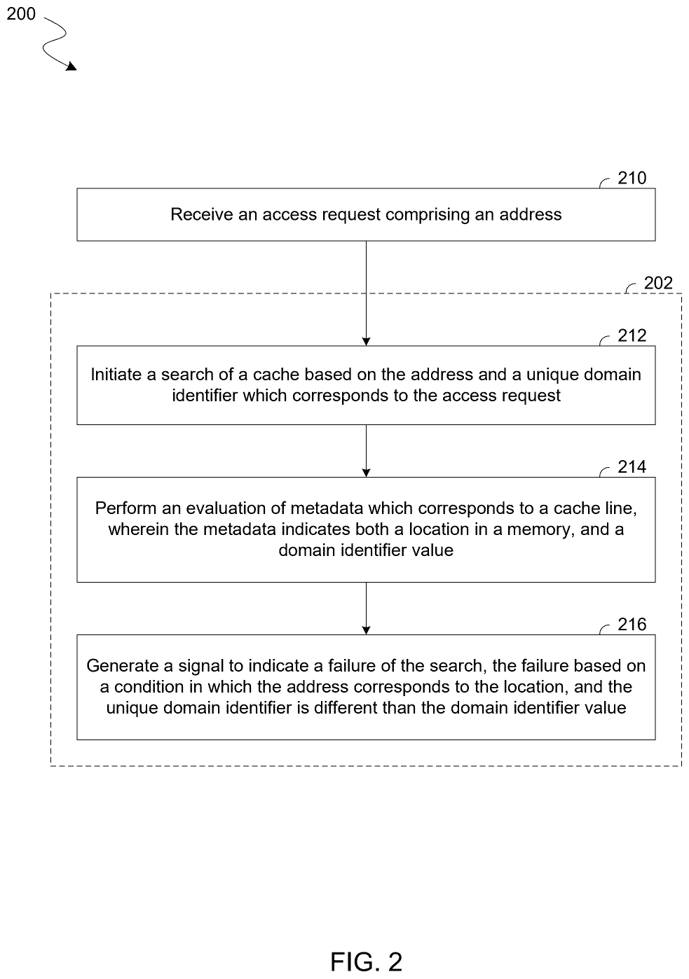

FIG. 2 shows a method 200 for searching a cache based on an execution domain identifier according to an embodiment. Method 200 illustrates one example of an embodiment wherein an execution domain, with which a memory access request is generated, is one basis for determining whether metadata for a given cache line satisfies a cache search criteria. Operations such as those of method 200 are performed with any of various combinations of suitable hardware (e.g., circuitry), firmware and/or executing software which, for example, provide some or all of the functionality of core circuitry 106.

As shown in FIG. 2, method 200 comprises (at 210) receiving an access request comprising an address. In an embodiment, the address indicates a location in a memory that—for example—is coupled to a processor that performs method 200. For example, the access request targets the location for a memory read or a memory write. Alternatively, the access request comprises a request to flush a cache line which is currently associated with the address.

The access request corresponds to an execution domain which is assigned a unique domain identifier—e.g., wherein the access request is generated by a process which executes with the execution domain. In an example embodiment, the receiving at 210 comprises cache search unit 140 receiving memory access request 104 from execution domain 102a.

In various embodiments, method 200 further comprises operations 202 to service the access request that is received at 210. Operations 202 comprise (at 212) initiating a domain-specific search of a cache—i.e., wherein the search is based on each of the address and the unique identifier of the execution domain. For example, cache search unit 140 (or other suitable circuitry which performs operations 202) determines search parameters comprising an address parameter which is based on the address, and a domain identifier parameter which is based on the unique identifier of the execution domain.

In searching the cache, operations 202 (at 214) perform an evaluation of metadata which corresponds to a line of the cache. The evaluation of the metadata is to determine whether, for the purpose of the search, the cache line in question is to be considered a hit or a miss. In an embodiment, the metadata for the line specifies or otherwise indicates both an address value, and a domain identifier value. The evaluation performed at 214 detects for the presence or absence of a match condition wherein the address value is equal to (or otherwise corresponds to) the address parameter, and wherein the domain identifier value is equal to (or otherwise corresponds to) the domain identifier parameter. For example, evaluation performed at 214 is to determine whether the address value indicates the memory location targeted by the request, and whether the domain identifier value indicates the execution domain with which the access request was generated.

Based on the evaluation performed at 214, operations 202 (at 216) generate a signal to indicate a failure of the search—e.g., wherein the failure includes (or is otherwise at least based on) a failure of the evaluation at 214 to detect a presence of a match condition. In the example embodiment shown, the failure is based on a condition in which the address corresponds to the location indicated by the metadata, and in which the unique identifier of the execution domain is different than the domain identifier value.

In some embodiments, method 200 further comprises additional operations (not shown) including the receiving and servicing of another memory access request. For example, such additional operations service a second access request, at least in part, by performing a second cache search based on both a second domain identifier and a second address of the second access request. In one such embodiment, the second cache search detects a match condition wherein metadata for a given cache line is determined to match the domain-specific criteria of the search.

In some embodiments, method 200 services a request, generated with a given execution domain, to write to a location in a shared memory page which (for example) is mapped at the time to be read-only. In one such embodiment, method 200 performs additional operations (not shown) to implement a copy-on-write wherein a duplicate page is generated as a copy of the targeted memory page. Furthermore, an execution domain corresponding to the write request is enabled to access the duplicate page—e.g., wherein access to the original targeted page by that same execution domain is disabled.

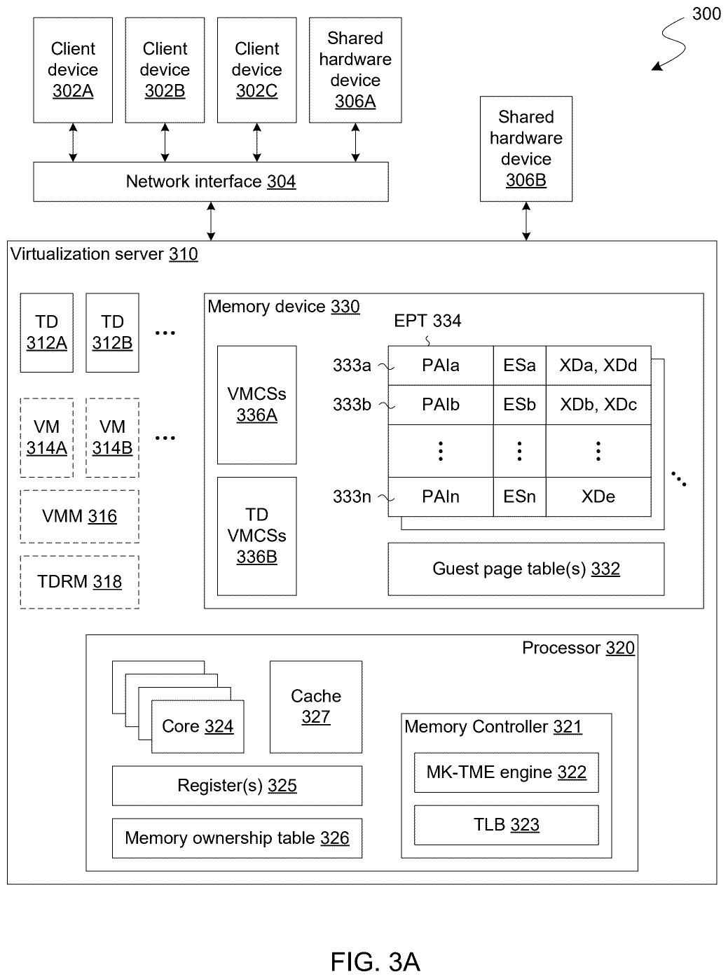

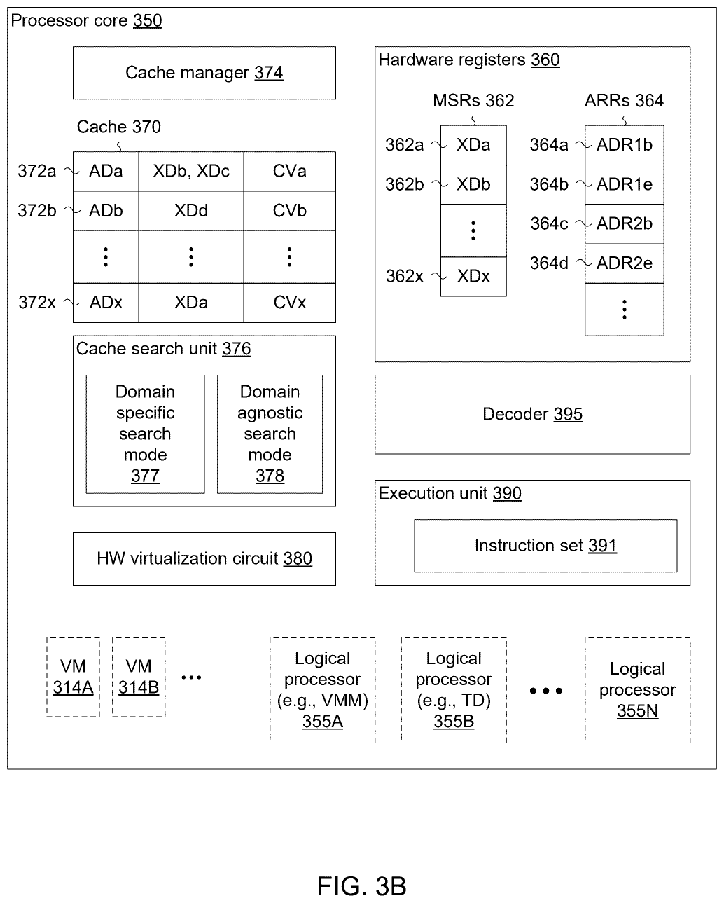

FIG. 3A illustrates an example computing system 300 to access a processor cache according to a domain-specific search mode according to an embodiment. System 300 is one example of an embodiment wherein processor core circuitry supports each of multiple cache search modes, including a domain-specific search mode and a domain-agnostic search mode. In some embodiments, system 300 provides functionality such as that of device 100—e.g., wherein operations of method 200 are performed with some or all of system 300.

As shown in FIG. 3A, computing system 300 comprises a network interface 304 and shared hardware devices 306A and 306B. A virtualization server 310 of system 300 includes, but is not limited to, a processor 320 and a memory device 330, e.g., comprising a main memory. The processor 320 executes a virtual machine monitor (VMM) 316, which is extended with a trusted domain resource manager (TDRM) 318. The VMM 316 controls one or more virtual machines (VMs) 314A, 314B. The TDRM 318 provides resource assignments to the VMs 314 and to one or more execution domains—e.g., including the illustrative trusted domains (TDs) 312A, and 312B shown.

In an illustrative scenario according to one embodiment, memory device 330 stores, among other information, guest page tables 332, extended page tables (EPT) 334, virtual machine control structures (VMCSs) 336A associated with the one or more VMs 314, and TD VMCSs 336B associated with the one or more TD's 312A, and 312B. By way of illustration and not limitation, memory device 330 includes dynamic random access memory (DRAM), synchronous DRAM (SDRAM), a static memory, such as static random access memory (SRAM), a flash memory, a data storage device, or other types of memory devices. For brevity, the memory device 330 is variably referred to as “memory” herein.

In an example embodiment, the processor 320 includes one or more processor cores 324, one or more registers 325, a cache 327, a memory ownership table 326, and a memory controller 321. In one such embodiment, memory controller 321 includes a MK-TME engine 322 (or other memory encryption engine) and a translation lookaside buffer (TLB) 323 that is to store address translation information and/or other state of a given one of a VMM, a VM, or the like. The MK-TME engine 322 encrypts data stored to the memory device 330, and decrypts data retrieved from the memory device 330 with appropriate encryption keys, e.g., a unique key assigned to the VM or the TD that is storing data to the memory device 330. Memory ownership table 326 illustrates any of various circuit resources which are suitable to provide a repository of information specifying or otherwise indicating an allocation of various memory resources (e.g., pages) each to a respective one or more execution domains.

A given client device 302 is (for example) one of a remote desktop computer, a tablet, a smartphone, another server, a thin/lean client, or the like. In various embodiments, some or all such client devices each execute a respective one or more applications on the virtualization server 310 in one or more execution domains (e.g., including the illustrative TDs 312A, and 312B shown) and, for example, with one or more of the VMs 314A, 314B. The VMM 316 executes a virtual machine environment that is to leverage hardware capabilities of a host and execute one or more guest operating systems, which support client applications that are run from the client devices 302A, 302B, and 302C, respectively.

In some embodiments, a single execution domain, such as the TD 312A, provides a secure execution environment to a single client 302A and supports a single guest OS. In other embodiments, one TD supports multiple tenants each running in a separate virtual machine and facilitated by a tenant VMM running inside the TD. The TDRM 318 in turn controls the TD's use of system resources, such as of the memory 330, the processor 320, and the shared hardware devices 306B. The TDRM 318 acts as a host and has control of the processor 320 and other platform hardware. A TDRM 318 assigns software in a TD (e.g., the TD 312A) with logical processor(s), but does not access a TD's execution state on the assigned logical processor(s). Similarly, the TDRM 318 assigns physical memory and I/O resources to a TD but not be privy to access/spoof the memory state of a TD due to separate encryption keys, and other integrity/replay controls on memory.

The TD 312A represents a software environment that supports a software stack that (for example) includes one or more VMMs, guest operating systems, and/or various application software hosted by the guest OS(s). The TD 312A operates independently of other TDs and uses logical processor(s), memory, and I/O assigned by the TDRM 318. In one such embodiment, software executing in the TD 312A operates with reduced privileges so that the TDRM 318 retains control of the platform resources. On the other hand, the TDRM 318 cannot access data associated with a TD or in some other way affect the confidentiality or integrity of a TD or replay data into the TD.

More specifically, the TDRM 318 (which incorporates the VMM 316) manages the key IDs associated with the encryption keys. In various embodiments, the TDRM 318 functions as a host for the TDs and has full control of the cores and other platform hardware. The TDRM 318 assigns software in a TD with logical processor(s). The TDRM 318, however, does not have access to a TD's execution state on the assigned logical processor(s). Similarly, the TDRM 318 assigns physical memory and I/O resources to the TDs, but is not privy to access the memory state of a TD due to the use of unique private encryption keys configured each for a respective TD. Software executing in the TDs operates with reduced privileges so that the TDRM 318 retains control of platform resources.

The VMM 316 further assigns logical processors, physical memory, encryption key IDs, I/O devices, and the like to TDs, but does not access the execution state of TDs and/or data stored in physical memory assigned to TDs. For example, the MK-TME engine 322 encrypts data and generate integrity check values before moving it from registers 325 or cache 327 to the memory 330 upon performing a “write” code. Conversely, the MK-TME engine 322 decrypts data (and verify its integrity using the associated integrity check value) when the data is moved from the memory 330 to the processor 320 following a read or write command.

In the example embodiment shown, EPT 334 comprises entries 333a, 333b, . . . , 333n which each correspond to a respective memory page, wherein each such entry 333 is to facilitate address translation for one or more addresses of the corresponding memory page. For example, entries 333a, 333b, . . . , 333n comprise page address information PAIa, page address information PAIb, . . . , and page address information PAIn (respectively) which variously facilitate translations each between a respective guest physical address and a respective host physical address.

To enable selective domain-specific cache searching according to some embodiments, entry 333a further comprises (or is otherwise associated with) an enablement state value ESa which specifies whether domain-specific cache searching—as opposed to an alternative domain-agnostic cache searching—is currently enabled for memory access requests which target the memory page corresponding to the page address information PAIa. Similarly, entry 333b further comprises (or is otherwise associated with) an enablement state value ESb which specifies whether domain-specific cache searching is currently enabled for memory access requests which target the memory page corresponding to the page address information PAIb. In addition, entry 333n further comprises (or is otherwise associated with) an enablement state value ESn which specifies whether domain-specific cache searching is currently enabled for memory access requests which target the memory page corresponding to the page address information PAIn.

In one such embodiment, VMM 316, or any of various other suitable agents, provide functionality to selectively (re)determine one or more of enablement state values ESa, ESb, . . . , ESn—e.g., based on input by a manufacturer, system administrator, cloud service customer and/or any of various other suitable agents. Some embodiments are not limited with respect to a particular agent by which, basis on which, and/or mechanism with which, a given enablement state value is determined. In various other embodiments, enablement state values ESa, ESb, . . . , ESn are instead provided outside of EPT 334—e.g., wherein one or more lookup tables and/or other suitable data structures (not shown) are further provided and/or otherwise used by VMM 316 (for example) to associate enablement state values ESa, ESb, . . . , ESn with entries 333a, 333b, . . . , 333n, respectively.

In some embodiments, domain-specific cache searching helps mitigate security risks which are traditionally of concern (for example) in the case of memory sharing in which multiple execution domains are assigned access to the same memory page. In one such embodiment, memory sharing is defined or otherwise indicated with configuration state values that are variously included in, or associated with, different entries of EPT 334. By way of illustration and not limitation, entry 333a includes (or is otherwise associated with) configuration state information indicating that a first memory page, which corresponds to page address information PAIa, is currently shared by two execution domains, which have respective domain identifiers XDa, XDd. Furthermore, line 333b includes, or is otherwise associated with, configuration state information indicating that a second memory page, which corresponds to page address information PAIb, is currently shared by two other execution domains, which have respective domain identifiers XDb, XDc. Further still, line 333n includes, or is otherwise associated with, configuration state information indicating that a third memory page, which corresponds to page address information PAIn, is not currently shared, but instead is accessible by one execution domain, which has domain identifier XDe.

In the example embodiment shown, the sharing of the first memory page is indicated by multiple domain identifiers—i.e., XDa, and XDd—being provided in a single line 333a of EPT 334. Similarly, the sharing of the second memory page is indicated by multiple domain identifiers—i.e., XDb, and XDc—being provided in a single line 333b. In an alternative embodiment, the sharing of a given page is instead indicated by multiple concurrent EPT entries which (for example) each have the same address information, and the same enablement state value, but which each include or otherwise correspond to a different respective domain identifier.

By way of illustration, in one such alternate embodiment, entry 333a instead comprises the domain identifier XDa, but not also the domain identifier XDd, while some other entry (not shown) of EPT 334 comprises the page address information PAIa, the enablement state value ESa, and the domain identifier XDd. Alternatively or in addition, in one such alternate embodiment, entry 333b instead comprises the domain identifier XDb, but not also the domain identifier XDc, while some other EPT entry comprises the page address information PAIb, the enablement state value ESb, and the domain identifier XDc.

In various other embodiments, the associations of memory pages, each with a respective one or more domains which share said memory page, are instead identified outside of EPT 334—e.g., wherein one or more lookup tables and/or other suitable data structures (not shown) are further provided and/or otherwise used to define associations of domain identifiers XDa, XDb, XDc, XDd, XDe, for example, each with a respective one of of entries 333a, 333b, . . . , 333n.

FIG. 3B shows an illustrative processor core 350 which supports multiple cache search modes including a domain-specific search mode according to an embodiment. Processor core 350 is one of cores 324 and/or includes core circuitry 106, for example.

In the embodiment illustrated in FIG. 3B, processor core 350 includes a cache 370 (e.g., one or more levels of cache 130), a hardware (HW) virtualization support circuit 380, and hardware registers 360. The hardware registers 360 include, for example, a number of model-specific registers 362 (or MSRs) and address range registers 364.

In one such embodiment, a decoder 395 of processor core 350 comprises circuitry to decode instructions which are based on an instruction set 391. The instruction set 391 comprises one or more instructions to write to, read from, or otherwise access a memory resource (e.g., at a system memory, or a cache memory) which core 350 is to be coupled to or, alternatively, includes. An execution unit 390 of processor core 350 comprises circuitry to variously execute one or more decoded instructions which are based on (e.g., according to or otherwise compatible with) instruction set 391.

In some embodiments, the processor core 350 executes instructions to run a number of hardware threads, also known as logical processors, including the first logical processor 355A, a second logical processor 355B, and so forth, until an Nth logical processor 355N. In one embodiment, the first logical processor 355A is the VMM 316. A number of VMs 314 are executed and controlled by the VMM 316, in various embodiments. In some embodiments, the TDRM 318 schedules an execution domain (in this example, a TD) for execution on a logical processor 355 of processor core 350. By way of illustration and not limitation, the virtualization server 310 executes one or more (TDX-based) VMs 314 with a TD for one or more client devices 302A-C.

In various embodiments, processor core 350 comprises one or more execution domain identifier (XDID) model-specific registers (MSRs)—e.g., including the illustrative MSR 362 shown—that are available (to VMM 316, for example) for specifying or otherwise determining a XDID for a given domain that is associated with a thread. In an embodiment, VMM 316, virtual machine control structures 336A, TD VMCSs 336B and/or other suitable logic uses the domain identifiers, which are variously assigned or otherwise identified in MSRs 362a, 362b, . . . , 362x, to associate page sharing information with address information of EPT 334 (e.g., by providing domain identifier sets each at a respective one of entries 333).

Cache 370 comprises multiple cache lines 372—e.g., including the illustrative lines 372a, 372b, . . . , 372x—which include (for example, are indexed by or tagged with) and/or are otherwise associated with respective metadata. For example, lines 372 comprise respective first fields each to provide a cached version of information which is at a corresponding memory location. In some embodiments, lines 372 each further comprise, or are otherwise associated with, a respective one or more other fields which provide metadata for the cached information in the corresponding first field. For example, a given one such other field provides a metadata value to specify or otherwise indicate an address for a memory location which corresponds to the cache line in question. Alternatively or in addition, a given one such other field provides a metadata value to specify or otherwise one or more unique domain identifiers or, in some embodiments, a default domain identifier.

During operation of processor core 350, the execution of at least some instructions by execution unit 390 results in information being variously cached to respective lines of cache 370. Based on the domain identifiers provided with MSRs 362—and in some embodiments, further based on page sharing information such as that in EPT 334—a VMM, a cache manager 374 (e.g., cache manager 120) and/or other suitable logic variously provides metadata for such information in different lines of cache 370.

For example, line 372a provides a cached version CVa of information at a first memory location. Furthermore, line 372a includes (or is otherwise associated with) metadata corresponding to CVa. By way of illustration and not limitation, line 372a includes address information ADa which specifies or otherwise indicates the first memory location. In one such embodiment, line 372a further includes one or more unique identifiers (in this example, identifiers XDb, XDc) each of a respective domain which shares that page comprising the first memory location. Alternatively, line 372a includes only a default domain identifier—e.g., in the case where the page comprising the first memory location is not shared.

Furthermore, line 372b provides a cached version CVb of information at a second memory location, and includes, or is otherwise associated with, metadata corresponding to CVb. For example, line 372b includes address information ADb which specifies or otherwise indicates the second memory location, and further includes a default identifier or, alternatively, one or more unique identifiers (in this example, identifier XDd) each of a respective domain which shares that page comprising the second memory location.

Further still, line 372x provides a cached version CVx of information at a third memory location, and includes, or is otherwise associated with, metadata corresponding to CVx. For example, line 372x includes address information ADx which specifies or otherwise indicates the third memory location, and further includes a default identifier or, alternatively, one or more unique identifiers (in this example, identifier XDa).

Cache search unit 376 of processor core 350—e.g., the cache search unit 376 corresponding functionally to cache search unit 140—supports a domain-specific search mode (DSSM) 377, a search criteria of which includes both an address parameter and a domain identifier parameter. Furthermore, cache search unit 376 supports a domain-agnostic search mode 378, a search criteria of which also includes the address parameter, but which is independent of (e.g., which omits) any such domain identifier parameter.

In an illustrative scenario according to one embodiment, cache search unit 376 performs a first search of cache 370 according to the domain-specific mode 377. For example, a first memory access request—from a VM (or other suitable process) which executes with an execution domain having identifier XDa—comprises an address ADx. Servicing the first memory access request comprises cache search unit 376 determining—e.g., based on EPT 334—that address ADx corresponds to the page address information PAIa (in entry 333a) for a location in a first memory page. Based on the enablement state value ESa of the entry 333a, cache search unit 376 further determines that searching of cache 370 is to be according to domain-specific mode 377. The first search results in cache search unit 376 detecting a match condition for line 372x of cache 370, wherein the match condition comprises both a match for address ADx and a match for the domain identifier XDa.

Additionally or alternatively, cache search unit 376 performs a second search of cache 370 according to the domain-specific mode 377. For example, a second memory access request—from another VM which executes with an execution domain having identifier XDd—comprises an address ADb. Servicing the second memory access request comprises cache search unit 376 determining—e.g., based on EPT 334—that address ADb also corresponds to the page address information PAIa and the first memory page. Based on the enablement state value ESa of the entry 333a, cache search unit 376 further determines that the second search of cache 370 is also to be according to domain-specific mode 377. The second search results in cache search unit 376 detecting a match condition for line 372b of cache 370, wherein the match condition comprises both a match for address ADb and a match for the domain identifier XDd.

Additionally or alternatively, cache search unit 376 performs a third search of cache 370 according to the domain-agnostic mode 378. For example, a third memory access request comprises an address ADb which corresponds to a page which is not shared by multiple execution domains. The third search results in cache search unit 376 detecting a match condition for a different line of cache 370, wherein the match condition comprises a match for the address, but is independent of any unique domain identifier.

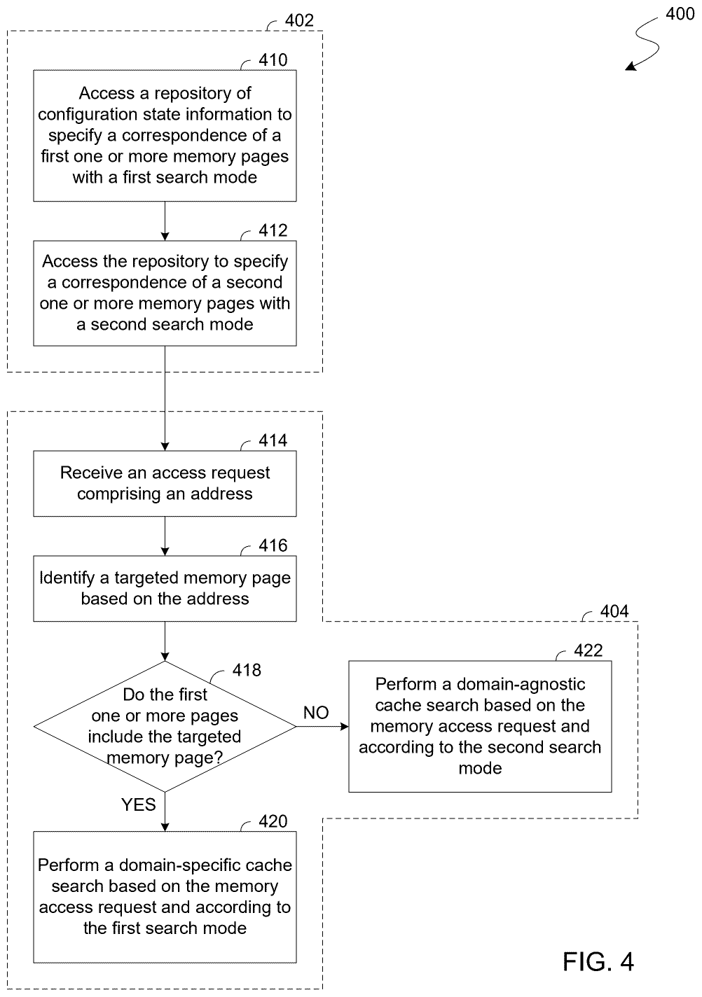

FIG. 4 shows a method 400 for determining a mode by which a cache is to be searched according to an embodiment. The method 400 illustrates one example of an embodiment wherein any of multiple cache search modes are made available, the cache search modes including one domain-specific search mode and one domain-agnostic search mode. Method 400 includes operations of method 200, and/or is performed with any of various combinations of suitable hardware (e.g., circuitry), firmware and/or executing software which, for example, provide functionality of device 100, system 300, or processor core 350.

As shown in FIG. 4, method 400 comprises operations 402 which selectively enable, for each of one or more domain identifiers, one of a first or a second cache search mode. In some embodiments, operations 402 comprise (at 410) accessing a repository of configuration state information to specify a correspondence of a first one or more memory pages with a first search mode which, in this example, is a domain-specific search mode (DSSM). Operations 402 further comprise (at 412) accessing the repository to specify a correspondence of a second one or more memory pages with a second search mode which, in this example, is a domain-agnostic search mode. For example, the accessing at 410 (or at 412) comprises VMM 316, TDRM 318, TD VMCSs 336B and/or other suitable logic accessing EPT 334 to write or otherwise determine the value of one of the illustrative enablement state values ESa, ESb, . . . , ESn. In some embodiments, a given one such enablement state value is specific to only a particular one or more memory pages.

Additionally or alternatively, method 400 comprises operations 404 to perform a search based on the enabled one of a first or a second cache search mode. Operations 404 comprise (at 414) receiving an access request comprising an address—e.g., wherein the receiving at 414 comprises features of the receiving at 210 of method 200. Based on the access request received at 414, operations 404 (at 416) identify a memory page which is targeted by the address. Operations 404 further perform an evaluation to detect (at 418) whether the first one or more pages include the targeted memory page. By way of illustration and not limitation, the identifying at 416 comprises identifying an entry of an EPT as corresponding to the address. In one such embodiment, the evaluation performed at 418 includes identifying an enablement state value which the EPT entry includes or is otherwise associated with.

Where it is determined at 418 that the first one or more pages include the targeted memory page, operations 404 (at 420) performs a domain-specific cache search based on the memory access request, and according to the first search mode. However, where it is instead determined at 418 that the first one or more pages do not include the targeted memory page (e.g., that the second one or more pages include the targeted memory page), operations 404 (at 422) performs a domain-agnostic cache search based on the memory access request and according to the second search mode.

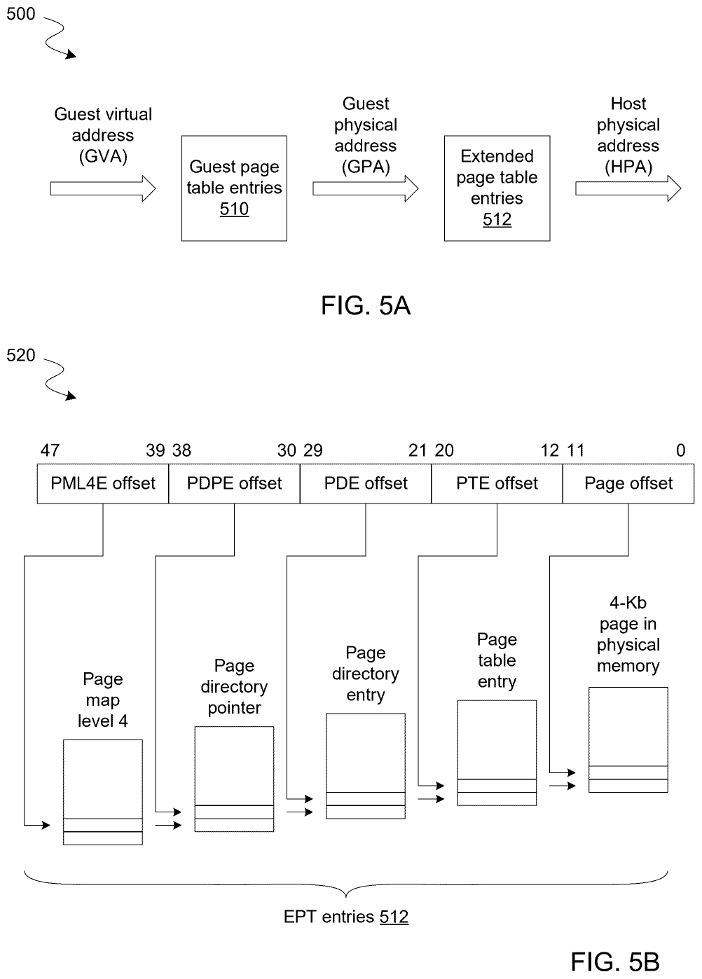

FIG. 5A is a block diagram 500 illustrating translation of a guest virtual address (GVA) to a guest physical address (GPA) and of the GPA to a host physical address (HPA), or a physical memory address, according to an implementation. In some embodiments, the translation illustrated by diagram 500 is performed with device 100 or system 300—e.g., wherein such translation includes or otherwise facilitates operations of one or methods 200, 400.

In the example embodiment illustrated by diagram 500, a hypervisor (e.g., VMM 316), in order to emulate an instruction on behalf of a virtual machine, translates a linear address (e.g., a GVA) used by the instruction to a physical memory address such that the hypervisor is able to access information at that physical address. In one example embodiment, in order to perform that translation, the hypervisor first determines paging and segmentation including examining a segmentation state of the virtual machine. The virtual machine executes within an execution domain such as one of TDs 312A, 312B. The hypervisor also determines a paging scheme of the virtual machine at the time of instruction invocation, including examining page tables set up by the virtual machine and examining hardware registers (e.g., control registers and MSRs such as those of registers 325) programmed by the hypervisor. Following discovery of paging and segmentation schemes, the hypervisor generates a GVA for a logical address, and detect any segmentation faults.

Assuming no segmentation faults are detected, the hypervisor translates the GVA to a GPA and the GPA to an HPA, including performing a page table walk with circuitry and/or in software. To perform these translations in software, the hypervisor loads a number of paging structure entries and EPT entries originally set up by the virtual machine into general purpose hardware registers or memory. Once these paging and EPT entries are loaded, the hypervisor performs the translations by modeling translation circuitry such as a page miss handler (PMH).

More specifically, with reference to FIG. 5A, the hypervisor loads a plurality of guest page table entries 510 (e.g., from the guest page tables 332) and a plurality of extended page table entries 512 (e.g., from one or more EPTs such as EPT 334) that were established by the virtual machine. The hypervisor then performs translation by walking (e.g., sequentially searching) through the guest page table entries 510 to generate a GPA from the GVA. The hypervisor then uses the GPA to walk (e.g., sequentially search) the EPT 512 to generate the HPA associated with the GPA. Use of the EPT 512 is a feature that is available for use to support the virtualization of physical memory. When EPT is in use, certain addresses that would normally be treated as physical addresses (and used to access memory) are instead treated as guest-physical addresses. Guest-physical addresses are translated by traversing a set of EPT paging structures to produce physical addresses that are used to access physical memory.

FIG. 5B is a block diagram 520 illustrating use of EPT to translate the GPA to the HPA, according to one implementation. For example, the guest physical address (GPA) is broken into a series of offsets, each to search within a table structure of a hierarchy of the EPT entries 512. In this example, the EPT from which the EPT entries are derived includes a four-level hierarchal table of entries, including a page map level 4 table, a page directory pointer table, a page directory entry table, and a page table entry table.

In other implementations, a different number of levels of hierarchy exist within the EPT, and therefore, some disclosed embodiments are not to limited to a particular implementation of the EPT. A result of each search at a level of the EPT hierarchy is added to the offset for the next table to locate a next result of the next level table in the EPT hierarchy. In the example embodiment shown, the result of the fourth (page table entry) table is combined with a page offset to locate a 4 Kb page (for example) in physical memory, which is the host physical address.

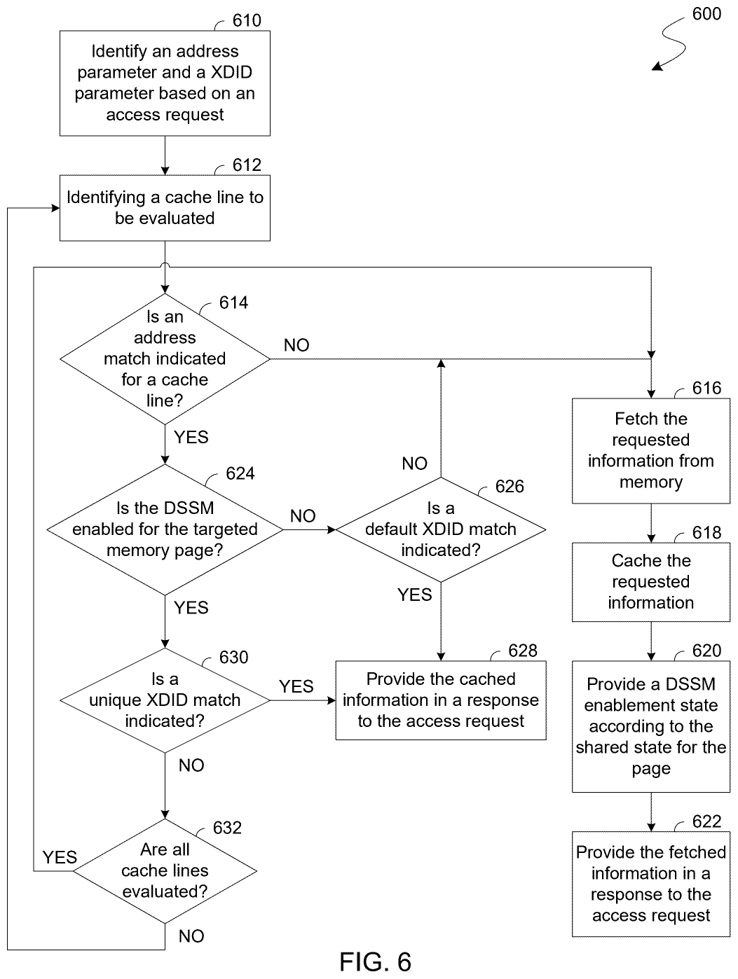

FIG. 6 shows a flow diagram illustrating features of a method to perform a cache search according to an embodiment. In various embodiments, operations such as those of method 600 are performed with core circuitry 106, system 300, or processor core 350—e.g., wherein method 600 includes or is otherwise based on operations of one of methods 200, 400.

As shown in FIG. 6, method 600 comprises (at 610) identifying an address parameter and a XDID parameter based on an access request. Method 600 further comprises (at 612) identifying a cache line for which an evaluation is to be performed as part of a cache search to facilitate servicing of the access request.

Method 600 further performs an evaluation (at 614) to determine whether an address match condition is indicated for the cache line most recently identified at 612. For example, the evaluation at 614 is to identify whether metadata for the cache line corresponds to the address parameter—e.g., including determining whether the cache line includes, is indexed by, or is otherwise associated with an address value that is equal to, or otherwise corresponds to, the address parameter.

Where it is determined at 614 that no such metadata for the cache line corresponds to the address parameter, method 600 (at 616) fetches the requested information from the (non-cache) memory location which is indicated by the access request. Furthermore, method 600 (at 618) caches a version of the requested information to a new line of the cache. Further still, method 600 (at 620) provides a DSSM enablement state—e.g., with metadata for the new cache line—which is according to a shared state of the memory page indicated by the access request. For example, the DSSM enablement state is to enable a DSSM if (and, for example, only if) the indicated memory page is currently shared by multiple execution domains. Method 600 further provides the fetched information (at 622) in a response to the access request.

Where it is instead determined at 614 that metadata for the cache line corresponds to the address parameter, method 600 performs another evaluation (at 624) to determine whether a DSSM is enabled for the targeted memory page—i.e., the memory page indicated by the access request.

Where it is determined at 624 that DSSM is not enabled for the targeted memory page, method 600 performs another evaluation (at 626) to determine whether a default XDID value for the cache line matches the domain identifier parameter. Where it is determined at 626 that there is no such match with a default XDID value, method 600 performs the various fetching, caching, etc. at 616, 618, 620, and 622. Where it is instead determined at 626 that a match with the default XDID value is indicated, method 600 (at 628) provides the cached information in a response to the access request.

Where it is instead determined at 624 that DSSM is enabled for the targeted memory, method 600 performs another evaluation (at 630) to determine whether a unique XDID value for the cache line matches the domain identifier parameter. Where it is determined at 630 that a match with the unique XDID value is indicated, method 600 provides the cached information in a response to the access request (at 628).

Where it is instead determined at 630 that no such match with the unique XDID value is indicated, method 600 performs another evaluation (at 632) to determine whether all candidate lines of the cache have been evaluated by the cache search. Where it is determined at 632 that one or more lines of the cache remain to be evaluated, method 600 performs a next instance of the identifying at 612. Where it is instead determined at 632 that all candidate lines of the cache have been evaluated, method 600 (at 616) performs the various fetching, caching, etc. at 616, 618, 620, and 622.

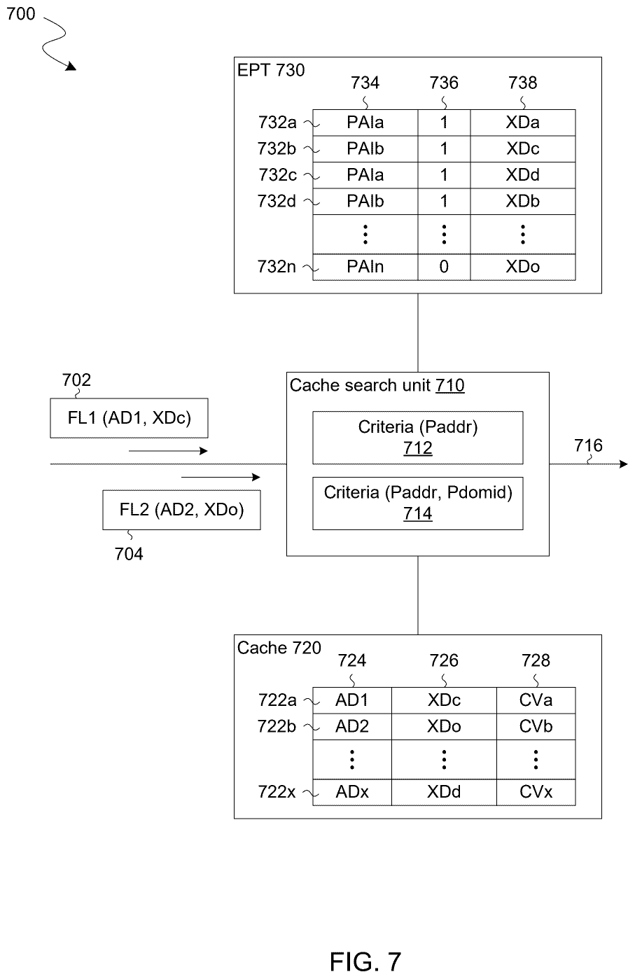

FIG. 7 shows a processor 700 which implements any of various cache search criteria according to an embodiment. The processor 700 illustrates features of one example embodiment wherein processor circuitry is operable to service a cache flush (cflush) request by selectively removing a cache line—if any—which satisfies a search criteria according a corresponding cache search mode. In an embodiment, the processor circuitry is able to selectively operate according to any of multiple cache search modes which, for example, include a domain-specific search mode and a domain-agnostic search mode. In some embodiments, processor 700 provides functionality such as that of core circuitry 106, processor 320, or processor core 350—e.g., wherein operations of one of methods 200, 400, 600 are performed with some or all of processor 700.

As shown in FIG. 7, processor 700 comprises a cache 720, a cache search unit 710, and an EPT 730 which (for example) correspond functionally to cache 370, cache search unit 376, and EPT 334, respectively. Cache 720 comprises multiple cache lines 722 (e.g., including the illustrative lines 722a, 722b, . . . , 722x) which are each indexed, tagged, and/or otherwise associated with respective metadata. For example, lines 722 each comprise a respective field 728 to provide a cached version of information which is at a corresponding memory location (e.g., including the illustrative cached versions CVa, CVb, . . . , CVx shown). In some embodiments, lines 722 each further comprise, or are otherwise associated with, a respective one or more other fields (e.g., including the illustrative fields 724, 726 shown) which provide metadata for the cached information in the corresponding field 728. For example, fields 724 of lines 722 provide respective metadata values—e.g., an indices, tags or the like—each to specify or otherwise indicate an address (such as one of the illustrative addresses AD1, AD2, . . . , ADx shown) for a corresponding memory location. Alternatively or in addition, fields 726 of lines 722 provide respective metadata values each to specify or otherwise indicate a set of one or more domain identifiers.

Cache search unit 710 supports a first cache search mode (e.g., corresponding functionally to domain-specific mode 377), a search criteria 714 of which includes both an address parameter Paddr and a domain identifier parameter Pdomid. Furthermore, cache search unit 710 supports a second cache search mode (e.g., corresponding functionally to domain-agnostic mode 378), a search criteria 712 of which includes the address parameter Paddr but which, for example is independent of—e.g., omits—any domain identifier parameter. Accordingly, the first cache search mode is a more constrained (“domain-specific”) mode, as compared to the relatively less constrained (“domain-agnostic”) second search search mode.

In an embodiment, EPT 730 variously provides page address information PAIa, page address information PAIb, . . . , and page address information PAIn with—for example—fields 734 of entries 732a, 732b, 732c, 732d, . . . , 732n. In one such embodiment, entries 732 each further comprise a respective field 736 to provide an enablement state value for the memory page to which the entry 732 in question corresponds. Furthermore, entries 732 each comprise a respective field 738 to specify or otherwise indicate one or more execution domains (if any) which currently have access to—and, for example, share—the memory page to which the entry 732 in question corresponds.

In an illustrative scenario according to one embodiment, cache search unit 710 is coupled to receive cache flush requests CF1 702, CF2 704 at various times, each from a different respective execution domain. Cache flush request CF1 702 comprises an address AD1, and is generated with a first execution domain having a unique domain identifier XDc. Servicing of CF1 702 comprises cache search unit 710 accessing EPT 730, based on address AD1, to identify entries 732b, 732d as corresponding to a first memory page. For example, cache search unit 710 determines that page address information PAIb, variously in entries 732b, 732d, facilitates a translation of address AD1 into a physical address of a location in the first memory page. Furthermore, cache search unit 710 determines from entry 732b that the first execution domain (having unique identifier XDc) currently has access to the first memory page. Further still, cache search unit 710 determines from entry 732d that a domain-specific search mode (DSSM) is enabled for requests to access the first memory page by the second execution domain (having unique identifier XDb).

Based on the DSSM being enabled for access requests which target the first memory page, cache search unit 710 performs a first search of cache 720, using criteria 714 to variously evaluate the respective metadata for some or all of lines 722. In one such embodiment, the first search detects a first match condition based on both the address parameter and the domain identifier parameter (e.g., based on address AD1 and domain identifier XDc). For example, detecting the first match condition comprises cache search unit 710 determining that the address AD1 in CF1 702 is equal (or otherwise corresponds) to the address value indicated in respective field 724 of line 722a. Furthermore, detecting the first match condition comprises cache search unit 710 determining that the domain identifier XDc—for the domain with which CF1 702 was generated—is equal (or otherwise corresponds) to the domain identifier value indicated in respective field 726 of line 722a. Based on the detected first match condition, cache search unit 710 flushes line 722a—e.g., wherein (at least) the cached version CVa is removed from the field 728 thereof. In an embodiment, cache search unit 710 generates a signal 716 which indicates a success (or in an alternative scenario, a failure) of the first search.

If, in an alternate scenario, CF1 702 instead included the unique domain identifier XDb of the second execution domain (rather than the unique domain identifier XDc of the first execution domain), then CF1 702 would fail to flush line 722a. Such a failure would be based on a mismatch of the domain identifier parameter with line 722a, and would be despite a match of the address parameter with line 722a.

By contrast, cache flush request CF2 704 comprises an address AD2, and is generated with a third execution domain having a unique domain identifier XDo. Servicing of CF2 704 comprises cache search unit 710 accessing EPT 730, based on address AD2, to identify an entry 732n which corresponds to a second memory page. For example, cache search unit 710 determines that page address information PAIn in entry 732n facilitates a translation of address AD2 into a physical address of a location in the second memory page. Furthermore, cache search unit 710 determines from entry 732n that a DSSM is disabled for requests to access the second memory page. In some embodiments, cache search unit 710 determines from entry 732n that the second memory page is not currently shared with any other execution domain. For example, the domain identifier XDo—for the domain with which CF2 704 was generated—is the only one which entry 732n associates with the second memory page.

Based on the DSSM being disabled for access requests which target the second memory page, cache search unit 710 performs a second search of cache 720, using criteria 712 to variously evaluate the respective metadata for some or all of lines 722. In one such embodiment, the second search detects a second match condition based on the address parameter (e.g., based on address AD2), but regardless of the domain identifier XDo. Based on the detected second match condition, cache search unit 710 flushes line 722b—e.g., wherein the cached version CVb is removed from the field 728 thereof. In one such embodiment, signal 716 additionally or alternatively indicates a success (or in an alternative scenario, a failure) of the second search.

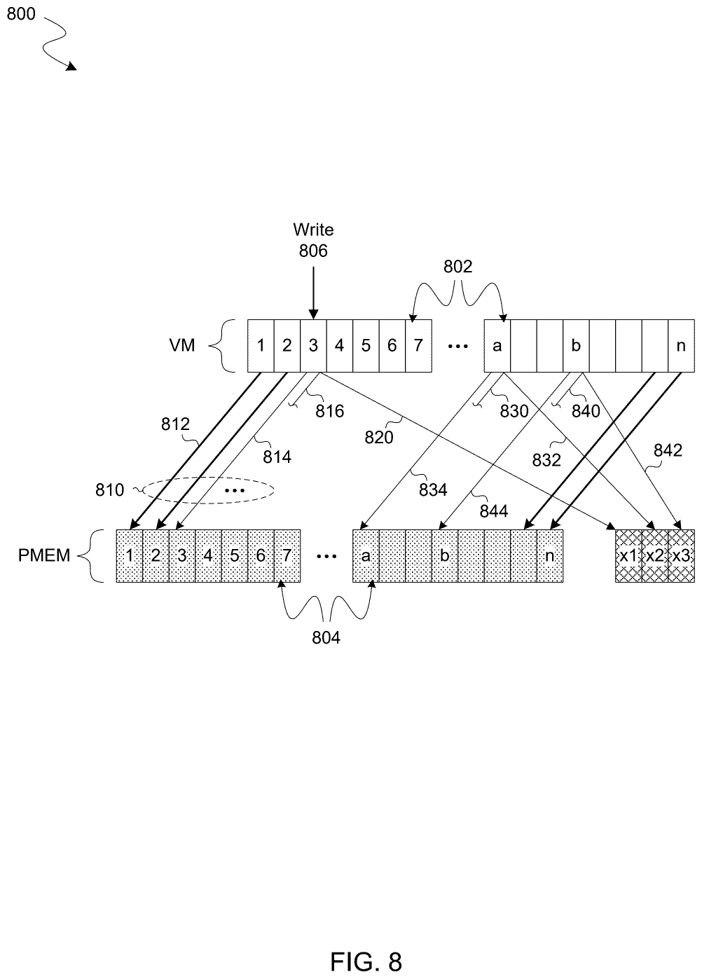

FIG. 8 illustrates operations 800 to facilitate a copy-on-write based on a domain-specific cache search according to an embodiment. Operations 800 illustrate one example embodiment wherein any of various suitable types of logic (e.g., comprising hardware, firmware and/or executing software)—such as that of a VMM, a memory manager, and/or the like—generate a copy of a shared memory page based on a detected attempt to write to said page. In some embodiments, operations 800 are performed with resources of core circuitry 106, virtualization server 310, processor core 350 or processor 700—e.g., wherein one of methods 200, 400, 600 include, are performed in combination with, or are otherwise based on operations 800.

By way of illustration and not limitation, a number of read-writable virtual memory pages (1 through n) 802 of a VM 314 (for example) are mapped to a corresponding number of read-writable physical memory pages (1 through n) 804 of a persistent memory (PMEM)—e.g., at memory device 330—that have been at least temporarily designated or marked (e.g., through their mappings) as read-only. The correspondences 810 shown—e.g., including a correspondence 812 of virtual page #1 to a physical memory page #1—illustrate how, at a given time, various ones of virtual memory pages 802 each correspond with a respective one of physical memory pages 804. For example, read-only designation/marking are made to override original read-write access permissions, e.g., for security reasons, for backing up the physical memory pages (1 through n) 804 of the persistent memory, or the like. In an embodiment, the original set of access permissions are stored in a working mapping data set (not shown) while the access permissions are temporarily altered. The provisioning of such access permissions include operations adapted (for example) from conventional memory management techniques, which are not detailed herein to avoid obscuring certain features of various embodiments.

In various embodiments, when a guest application of a VM attempts a write to a shared one of virtual memory pages 802, while the targeted virtual memory page is mapped as read-only, memory access logic (such as that of a memory manager) allocates a first physical memory page, and copies, to the newly allocated first physical memory page, the data in a second physical memory page which corresponds to the shared virtual memory page. Furthermore, the memory access logic updates page sharing state information (e.g., at EPT 334, cache 370, cache 720, EPT 730 or the like) to associate the first physical memory page with one execution domain for the VM that attempted write. The update to the page sharing state information further disassociate the second physical memory page from the one execution domain, in some embodiments. Based on the updated page sharing state information, the write instead changes the data which is copied to the first physical memory page (i.e., rather than changing the older version of said data in the second physical memory page). In one such embodiment, the second physical memory page (and the older data therein) remains available for one or more other execution domains which, previously, shared the second physical memory page with the one execution domain.

In an illustrative scenario according to one embodiment, a guest application of a VM (which executes in a first execution domain) attempts a write 806 to a virtual memory page #3 of virtual memory pages 802, wherein the targeted virtual memory page #3 is shared by the first execution domain and a second execution domain, and corresponds to a physical memory page #3 (which is currently mapped as read-only) of physical memory pages 804. Based on the type of attempted memory access—i.e., a write access—a fault is generated due to an access permission violation, and memory access logic is invoked for a copy-on-write (COW) process. The memory access logic, on invocation, allocates another physical memory page x1, and copies the data in the physical memory page #3 to the newly-allocated physical memory page x1. Furthermore, the memory access logic updates page sharing state information (not shown) so that, for the purpose of access requests generated with the first execution domain, a correspondence 816 of virtual memory page #3 to physical memory page #3 is replaced with an alternative correspondence 820 of virtual memory page #3 to a write enabled physical memory page x1.

In an embodiment, correspondence 816 is replaced with correspondence 820 while another correspondence 814 is maintained—i.e., whereby, for the purpose of access requests generated with the second execution domain, the virtual memory page #3 continues to have the correspondence 814 with physical memory page #3. The write 806 then updates the physical memory page x1 which is newly accessible by the first execution domain, rather than updating the physical memory page #3 which remains accessible by the second execution domain. Thereafter, writes which address virtual memory page #3 on behalf of the first execution domain actually target physical memory page x1, whereas writes which address virtual memory page #3 on behalf of the second execution domain continue to target physical memory page #3.

As still another example, a VM executing in a third execution domain attempts a second write to a virtual memory page #a of virtual memory pages 802, wherein the targeted virtual memory page #a is shared by the third execution domain and a fourth execution domain, and corresponds to a physical memory page #a (which is currently mapped as read-only) of physical memory pages 804. The attempted second write causes memory access logic to be invoked to allocate another physical memory page x2, copy the data in the physical memory page #a to physical memory page x2, and update the page sharing state information so that, for the purpose of access requests generated with the third execution domain, a correspondence 830 of virtual memory page #a to physical memory page #a is replaced with an alternative correspondence 832 of virtual memory page #a to a write enabled physical memory page x2. However, for the purpose of access requests generated with the fourth execution domain, the virtual memory page #a continues to have a correspondence 834 with physical memory page #a. The second write then updates the physical memory page x2 (rather than physical memory page #a).

As a further example, a VM executing in a fifth execution domain attempts a third write to a virtual memory page #b of virtual memory pages 802, wherein the targeted virtual memory page #b is shared by the fifth execution domain and a sixth execution domain, and corresponds to a physical memory page #b (which is currently mapped as read-only) of physical memory pages 804. The attempted third write causes memory access logic to be invoked to allocate another physical memory page x3, copy the data in the physical memory page #b to physical memory page x3, and update the page sharing state information so that, for the purpose of access requests generated with the fifth execution domain, a correspondence 840 of virtual memory page #b to physical memory page #b is replaced with an alternative correspondence 842 of virtual memory page #b to a write enabled physical memory page x3. However, for the purpose of access requests generated with the sixth execution domain, the virtual memory page #b continues to have a correspondence 844 with physical memory page #b. The third write then updates the physical memory page x3 (rather than physical memory page #b).

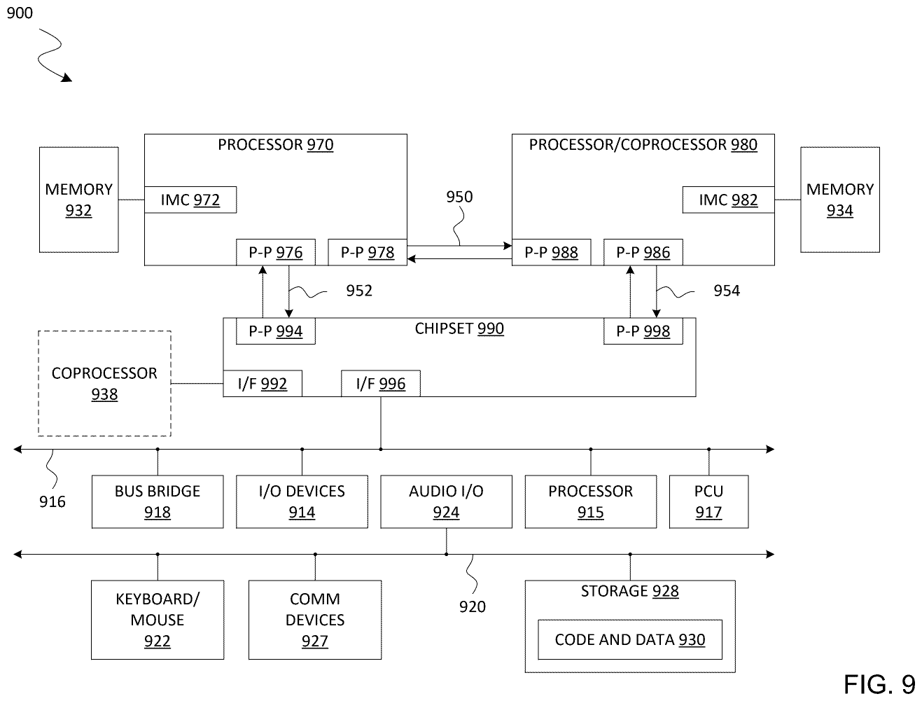

FIG. 9 illustrates an exemplary system. Multiprocessor system 900 is a point-to-point interconnect system and includes a plurality of processors including a first processor 970 and a second processor 980 coupled via a point-to-point interconnect 950. In some examples, the first processor 970 and the second processor 980 are homogeneous. In some examples, first processor 970 and the second processor 980 are heterogenous. Though the exemplary system 900 is shown to have two processors, the system may have three or more processors, or may be a single processor system.

Processors 970 and 980 are shown including integrated memory controller (IMC) circuitry 972 and 982, respectively. Processor 970 also includes as part of its interconnect controller point-to-point (P-P) interfaces 976 and 978; similarly, second processor 980 includes P-P interfaces 986 and 988. Processors 970, 980 may exchange information via the point-to-point (P-P) interconnect 950 using P-P interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a chipset 990 via individual P-P interconnects 952, 954 using point to point interface circuits 976, 994, 986, 998. Chipset 990 may optionally exchange information with a coprocessor 938 via an interface 992. In some examples, the coprocessor 938 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 970, 980 or outside of both processors, yet connected with the processors via P-P interconnect, such that either or both processors' local cache information may be stored in the shared cache if a processor is placed into a low power mode.

Chipset 990 may be coupled to a first interconnect 916 via an interface 996. In some examples, first interconnect 916 may be a Peripheral Component Interconnect (PCI) interconnect, or an interconnect such as a PCI Express interconnect or another I/O interconnect. In some examples, one of the interconnects couples to a power control unit (PCU) 917, which may include circuitry, software, and/or firmware to perform power management operations with regard to the processors 970, 980 and/or co-processor 938. PCU 917 provides control information to a voltage regulator (not shown) to cause the voltage regulator to generate the appropriate regulated voltage. PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software.

Various I/O devices 914 may be coupled to first interconnect 916, along with a bus bridge 918 which couples first interconnect 916 to a second interconnect 920. In some examples, one or more additional processor(s) 915, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 916. In some examples, second interconnect 920 may be a low pin count (LPC) interconnect. Various devices may be coupled to second interconnect 920 including, for example, a keyboard and/or mouse 922, communication devices 927 and a storage circuitry 928. Storage circuitry 928 may be one or more non-transitory machine-readable storage media as described below, such as a disk drive or other mass storage device which may include instructions/code and data 930 in some examples. Further, an audio I/O 924 may be coupled to second interconnect 920. Note that other architectures than the point-to-point architecture described above are possible. For example, instead of the point-to-point architecture, a system such as multiprocessor system 900 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

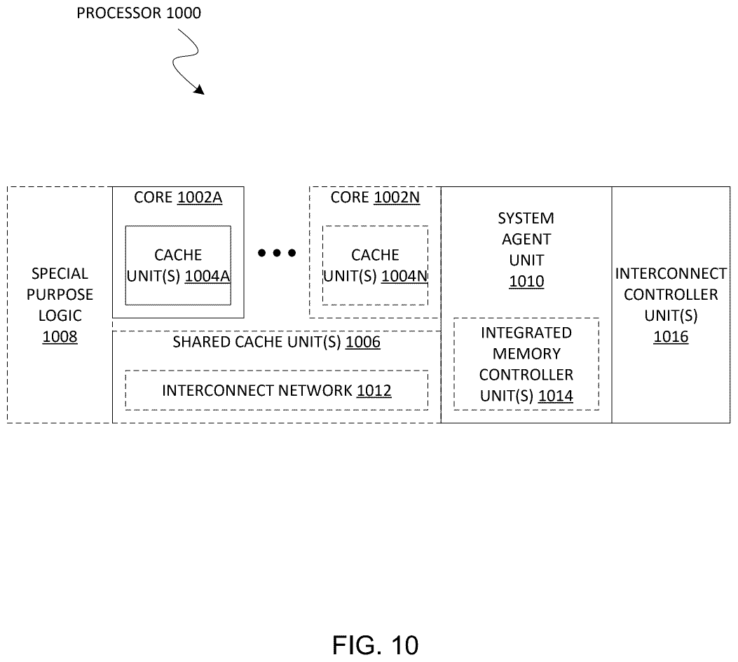

FIG. 10 illustrates a block diagram of an example processor 1000 that may have more than one core and an integrated memory controller. The solid lined boxes illustrate a processor 1000 with a single core 1002A, a system agent unit circuitry 1010, a set of one or more interconnect controller unit(s) circuitry 1016, while the optional addition of the dashed lined boxes illustrates an alternative processor 1000 with multiple cores 1002A-N, a set of one or more integrated memory controller unit(s) circuitry 1014 in the system agent unit circuitry 1010, and special purpose logic 1008, as well as a set of one or more interconnect controller units circuitry 1016. Note that the processor 1000 may be one of the processors 970 or 980, or co-processor 938 or 915 of FIG. 9.

Thus, different implementations of the processor 1000 may include: 1) a CPU with the special purpose logic 1008 being integrated graphics and/or scientific (throughput) logic (which may include one or more cores, not shown), and the cores 1002A-N being one or more general purpose cores (e.g., general purpose in-order cores, general purpose out-of-order cores, or a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1004A-N within the cores 1002A-N, a set of one or more shared cache unit(s) circuitry 1006, and external memory (not shown) coupled to the set of integrated memory controller unit(s) circuitry 1014. The set of one or more shared cache unit(s) circuitry 1006 may include one or more mid-level caches, such as level 2 (L2), level 3 (L3), level 4 (L4), or other levels of cache, such as a last level cache (LLC), and/or combinations thereof. While in some examples ring-based interconnect network circuitry 1012 interconnects the special purpose logic 1008 (e.g., integrated graphics logic), the set of shared cache unit(s) circuitry 1006, and the system agent unit circuitry 1010, alternative examples use any number of well-known techniques for interconnecting such units. In some examples, coherency is maintained between one or more of the shared cache unit(s) circuitry 1006 and cores 1002A-N.

In some examples, one or more of the cores 1002A-N are capable of multi-threading. The system agent unit circuitry 1010 includes those components coordinating and operating cores 1002A-N. The system agent unit circuitry 1010 may include, for example, power control unit (PCU) circuitry and/or display unit circuitry (not shown). The PCU may be or may include logic and components needed for regulating the power state of the cores 1002A-N and/or the special purpose logic 1008 (e.g., integrated graphics logic). The display unit circuitry is for driving one or more externally connected displays.

The cores 1002A-N may be homogenous in terms of instruction set architecture (ISA). Alternatively, the cores 1002A-N may be heterogeneous in terms of ISA; that is, a subset of the cores 1002A-N may be capable of executing an ISA, while other cores may be capable of executing only a subset of that ISA or another ISA.

### Exemplary Core Architectures-in-Order and Out-of-Order Core Block Diagram

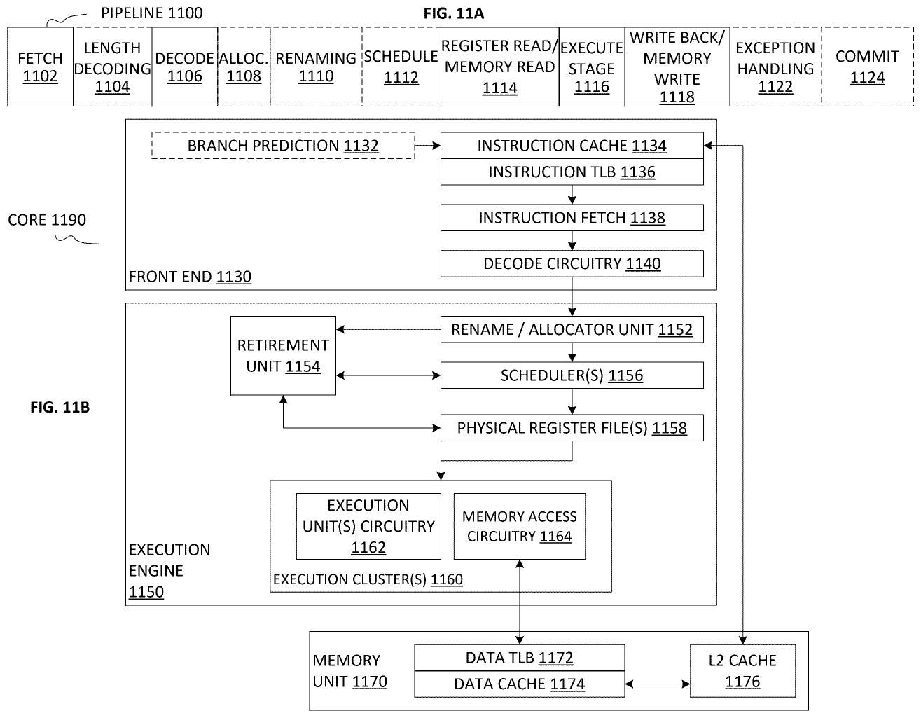

FIG. 11A is a block diagram illustrating both an exemplary in-order pipeline and an exemplary register renaming, out-of-order issue/execution pipeline according to examples. FIG. 11B is a block diagram illustrating both an exemplary example of an in-order architecture core and an exemplary register renaming, out-of-order issue/execution architecture core to be included in a processor according to examples. The solid lined boxes in FIGS. 11A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, an optional length decoding stage 1104, a decode stage 1106, an optional allocation (Alloc) stage 1108, an optional renaming stage 1110, a schedule (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, and during the decode stage 1106, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1106 and the register read/memory read stage 1114 may be combined into one pipeline stage. In one example, during the execute stage 1116, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 11B may implement the pipeline 1100 as follows: 1) the instruction fetch circuitry 1138 performs the fetch and length decoding stages 1102 and 1104; 2) the decode circuitry 1140 performs the decode stage 1106; 3) the rename/allocator unit circuitry 1152 performs the allocation stage 1108 and renaming stage 1110; 4) the scheduler(s) circuitry 1156 performs the schedule stage 1112; 5) the physical register file(s) circuitry 1158 and the memory unit circuitry 1170 perform the register read/memory read stage 1114; the execution cluster(s) 1160 perform the execute stage 1116; 6) the memory unit circuitry 1170 and the physical register file(s) circuitry 1158 perform the write back/memory write stage 1118; 7) various circuitry may be involved in the exception handling stage 1122; and 8) the retirement unit circuitry 1154 and the physical register file(s) circuitry 1158 perform the commit stage 1124.

FIG. 11B shows a processor core 1190 including front-end unit circuitry 1130 coupled to an execution engine unit circuitry 1150, and both are coupled to a memory unit circuitry 1170. The core 1190 may be a reduced instruction set architecture computing (RISC) core, a complex instruction set architecture computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit circuitry 1130 may include branch prediction circuitry 1132 coupled to an instruction cache circuitry 1134, which is coupled to an instruction translation lookaside buffer (TLB) 1136, which is coupled to instruction fetch circuitry 1138, which is coupled to decode circuitry 1140. In one example, the instruction cache circuitry 1134 is included in the memory unit circuitry 1170 rather than the front-end circuitry 1130. The decode circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1140 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1140 may be implemented using various different mechanisms. Examples of suitable mechanisms include, but are not limited to, look-up tables, hardware implementations, programmable logic arrays (PLAs), microcode read only memories (ROMs), etc. In one example, the core 1190 includes a microcode ROM (not shown) or other medium that stores microcode for certain macroinstructions (e.g., in decode circuitry 1140 or otherwise within the front end circuitry 1130). In one example, the decode circuitry 1140 includes a micro-operation (micro-op) or operation cache (not shown) to hold/cache decoded operations, micro-tags, or micro-operations generated during the decode or other stages of the processor pipeline 1100. The decode circuitry 1140 may be coupled to rename/allocator unit circuitry 1152 in the execution engine circuitry 1150.

The execution engine circuitry 1150 includes the rename/allocator unit circuitry 1152 coupled to a retirement unit circuitry 1154 and a set of one or more scheduler(s) circuitry 1156. The scheduler(s) circuitry 1156 represents any number of different schedulers, including reservations stations, central instruction window, etc. In some examples, the scheduler(s) circuitry 1156 can include arithmetic logic unit (ALU) scheduler/scheduling circuitry, ALU queues, arithmetic generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1158 includes vector registers unit circuitry, writemask registers unit circuitry, and scalar register unit circuitry. These register units may provide architectural vector registers, vector mask registers, general-purpose registers, etc. The physical register file(s) circuitry 1158 is coupled to the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution unit(s) circuitry 1162 and a set of one or more memory access circuitry 1164. The execution unit(s) circuitry 1162 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1156, physical register file(s) circuitry 1158, and execution cluster(s) 1160 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1164). It should also be understood that where separate pipelines are used, one or more of these pipelines may be out-of-order issue/execution and the rest in-order.

In some examples, the execution engine unit circuitry 1150 may perform load store unit (LSU) address/data pipelining to an Advanced Microcontroller Bus (AMB) interface (not shown), and address phase and writeback, data phase load, store, and branches.

The set of memory access circuitry 1164 is coupled to the memory unit circuitry 1170, which includes data TLB circuitry 1172 coupled to a data cache circuitry 1174 coupled to a level 2 (L2) cache circuitry 1176. In one exemplary example, the memory access circuitry 1164 may include a load unit circuitry, a store address unit circuit, and a store data unit circuitry, each of which is coupled to the data TLB circuitry 1172 in the memory unit circuitry 1170. The instruction cache circuitry 1134 is further coupled to the level 2 (L2) cache circuitry 1176 in the memory unit circuitry 1170. In one example, the instruction cache 1134 and the data cache 1174 are combined into a single instruction and data cache (not shown) in L2 cache circuitry 1176, a level 3 (L3) cache circuitry (not shown), and/or main memory. The L2 cache circuitry 1176 is coupled to one or more other levels of cache and eventually to a main memory.

The core 1190 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1190 includes logic to support a packed data instruction set architecture extension (e.g., AVX1, AVX2), thereby allowing the operations used by many multimedia applications to be performed using packed data.

### Exemplary Execution Unit(s) Circuitry

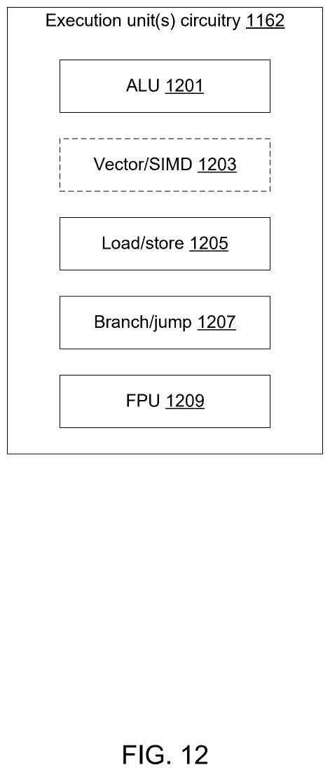

FIG. 12 illustrates examples of execution unit(s) circuitry, such as execution unit(s) circuitry 1162 of FIG. 11B. As illustrated, execution unit(s) circuity 1162 may include one or more ALU circuits 1201, optional vector/single instruction multiple data (SIMD) circuits 1203, load/store circuits 1205, branch/jump circuits 1207, and/or Floating-point unit (FPU) circuits 1209. ALU circuits 1201 perform integer arithmetic and/or Boolean operations. Vector/SIMD circuits 1203 perform vector/SIMD operations on packed data (such as SIMD/vector registers). Load/store circuits 1205 execute load and store instructions to load data from memory into registers or store from registers to memory. Load/store circuits 1205 may also generate addresses. Branch/jump circuits 1207 cause a branch or jump to a memory address depending on the instruction. FPU circuits 1209 perform floating-point arithmetic. The width of the execution unit(s) circuitry 1162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

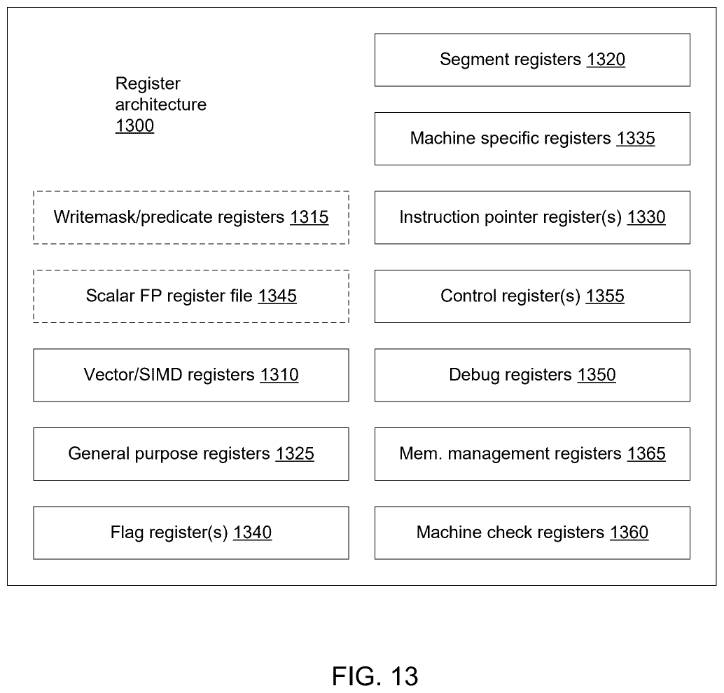

FIG. 13 is a block diagram of a register architecture 1300 according to some examples. As illustrated, the register architecture 1300 includes vector/SIMD registers 1310 that vary from 128-bit to 1,024 bits width. In some examples, the vector/SIMD registers 1310 are physically 512-bits and, depending upon the mapping, only some of the lower bits are used. For example, in some examples, the vector/SIMD registers 1310 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1300 includes writemask/predicate registers 1315. For example, in some examples, there are 8 writemask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1315 corresponds to a data element position of the destination. In other examples, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1300 includes scalar floating-point (FP) register 1345 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some examples, the one or more flag registers 1340 are called program status and control registers.

Segment registers 1320 contain segment points for use in accessing memory. In some examples, these registers are referenced by the names CS, DS, SS, ES, FS, and GS.

Machine specific registers (MSRs) 1335 control and report on processor performance. Most MSRs 1335 handle system-related functions and are not accessible to an application program. Machine check registers 1360 consist of control, status, and error reporting MSRs that are used to detect and report on hardware errors.

One or more instruction pointer register(s) 1330 store an instruction pointer value. Control register(s) 1355 (e.g., CR0-CR4) determine the operating mode of a processor (e.g., processor 970, 980, 938, 915, and/or 1000) and the characteristics of a currently executing task. Debug registers 1350 control and allow for the monitoring of a processor or core's debugging operations.

Memory (mem) management registers 1365 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1300 may, for example, be used in register file(s) circuitry 1158.

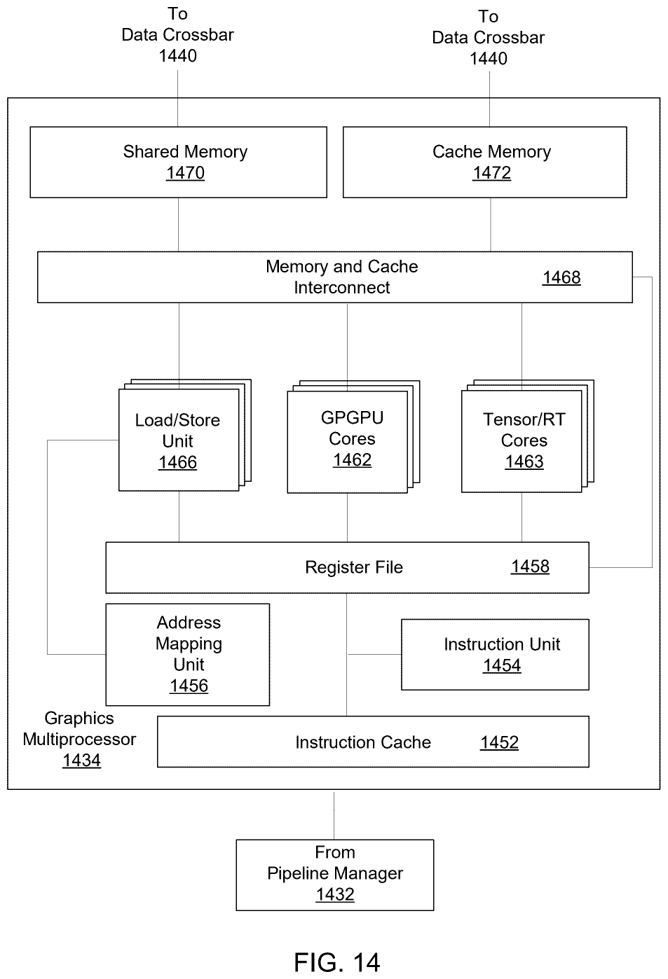

FIG. 14 shows an example of a graphics multiprocessor 1434 in which the graphics multiprocessor 1434 couples with the pipeline manager 1432 of a processing cluster. The graphics multiprocessor 1434 has an execution pipeline including but not limited to an instruction cache 1452, an instruction unit 1454, an address mapping unit 1456, a register file 1458, one or more general purpose graphics processing unit (GPGPU) cores 1462, and one or more load/store units 1466. The GPGPU cores 1462 and load/store units 1466 are coupled with cache memory 1472 and shared memory 1470 via a memory and cache interconnect 1468. The graphics multiprocessor 1434 may additionally include tensor and/or ray-tracing cores 1463 that include hardware logic to accelerate matrix and/or ray-tracing operations.

The instruction cache 1452 may receive a stream of instructions to execute from the pipeline manager 1432. The instructions are cached in the instruction cache 1452 and dispatched for execution by the instruction unit 1454. The instruction unit 1454 can dispatch instructions as thread groups (e.g., warps), with each thread of the thread group assigned to a different execution unit within GPGPU core 1462. An instruction can access any of a local, shared, or global address space by specifying an address within a unified address space. The address mapping unit 1456 can be used to translate addresses in the unified address space into a distinct memory address that can be accessed by the load/store units 1466.

The register file 1458 provides a set of registers for the functional units of the graphics multiprocessor 1434. The register file 1458 provides temporary storage for operands connected to the data paths of the functional units (e.g., GPGPU cores 1462, load/store units 1466) of the graphics multiprocessor 1434. The register file 1458 may be divided between each of the functional units such that each functional unit is allocated a dedicated portion of the register file 1458. For example, the register file 1458 may be divided between the different warps being executed by the graphics multiprocessor 1434.

The GPGPU cores 1462 can each include floating point units (FPUs) and/or integer arithmetic logic units (ALUs) that are used to execute instructions of the graphics multiprocessor 1434. In some implementations, the GPGPU cores 1462 can include hardware logic that may otherwise reside within the tensor and/or ray-tracing cores 1463. The GPGPU cores 1462 can be similar in architecture or can differ in architecture. For example and in some examples, a first portion of the GPGPU cores 1462 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 1434 can additionally include one or more fixed function or special function units to perform specific functions such as copy rectangle or pixel blending operations. One or more of the GPGPU cores can also include fixed or special function logic.

The GPGPU cores 1462 may include SIMD logic capable of performing a single instruction on multiple sets of data. Optionally, GPGPU cores 1462 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 1468 is an interconnect network that connects each of the functional units of the graphics multiprocessor 1434 to the register file 1458 and to the shared memory 1470. For example, the memory and cache interconnect 1468 is a crossbar interconnect that allows the load/store unit 1466 to implement load and store operations between the shared memory 1470 and the register file 1458. The register file 1458 can operate at the same frequency as the GPGPU cores 1462, thus data transfer between the GPGPU cores 1462 and the register file 1458 is very low latency. The shared memory 1470 can be used to enable communication between threads that execute on the functional units within the graphics multiprocessor 1434. The cache memory 1472 can be used as a data cache for example, to cache texture data communicated between the functional units and a texture unit. The shared memory 1470 can also be used as a program managed cached. The shared memory 1470 and the cache memory 1472 can couple with the data crossbar 1440 to enable communication with other components of the processing cluster. Threads executing on the GPGPU cores 1462 can programmatically store data within the shared memory in addition to the automatically cached data that is stored within the cache memory 1472.

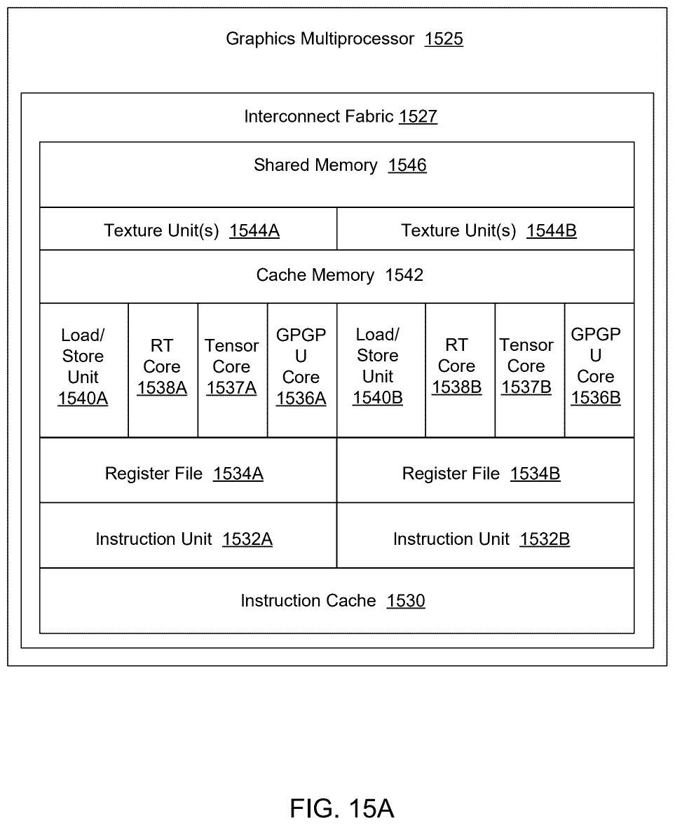

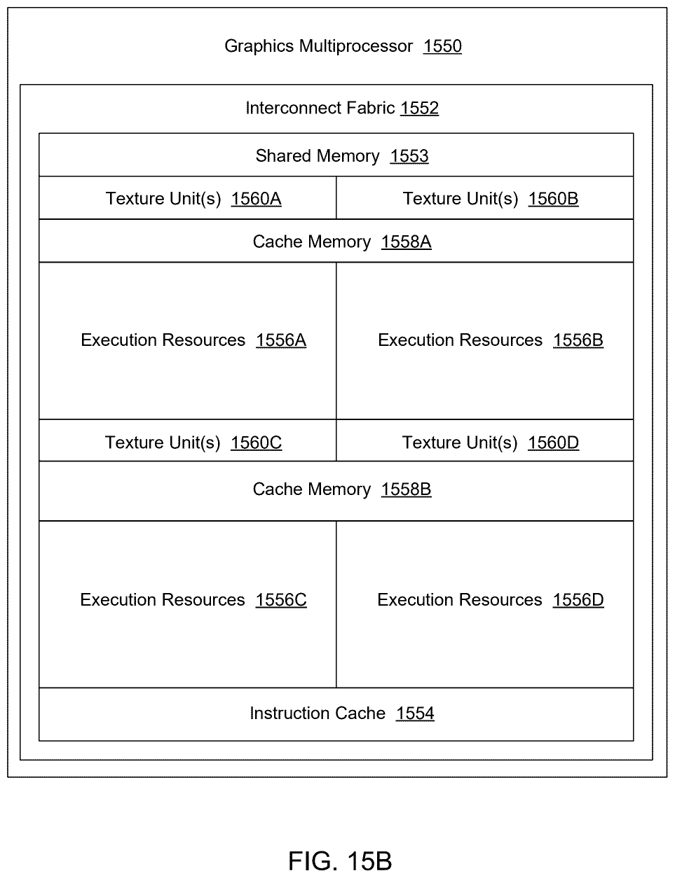

FIGS. 15A-15B illustrate additional graphics multiprocessors, according to examples. FIGS. 15A-15B illustrate graphics multiprocessors 1525, 1550. The disclosure of any features in combination with the graphics multiprocessor 1434 herein also discloses a corresponding combination with the graphics multiprocessors 1525, 1550, but is not limited to such. The illustrated graphics multiprocessors 1525, 1550 can be streaming multiprocessors (SM) capable of simultaneous execution of a large number of execution threads.

The graphics multiprocessor 1525 of FIG. 15A includes multiple additional instances of execution resource units relative to the graphics multiprocessor 1434 of FIG. 14. For example, the graphics multiprocessor 1525 can include multiple instances of the instruction unit 1532A-1532B, register file 1534A-1534B, and texture unit(s) 1544A-1544B. The graphics multiprocessor 1525 also includes multiple sets of graphics or compute execution units (e.g., GPGPU core 1536A-1536B, tensor core 1537A-1537B, ray-tracing core 1538A-1538B) and multiple sets of load/store units 1540A-1540B. The execution resource units have a common instruction cache 1530, texture and/or data cache memory 1542, and shared memory 1546.

The various components can communicate via an interconnect fabric 1527. The interconnect fabric 1527 may include one or more crossbar switches to enable communication between the various components of the graphics multiprocessor 1525. The interconnect fabric 1527 may be a separate, high-speed network fabric layer upon which each component of the graphics multiprocessor 1525 is stacked. The components of the graphics multiprocessor 1525 communicate with remote components via the interconnect fabric 1527. For example, the cores 1536A-1536B, 1537A-1537B, and 1538A-1538B can each communicate with shared memory 1546 via the interconnect fabric 1527. The interconnect fabric 1527 can arbitrate communication within the graphics multiprocessor 1525 to ensure a fair bandwidth allocation between components.

The graphics multiprocessor 1550 of FIG. 15B includes multiple sets of execution resources 1556A-1556D, where each set of execution resource includes multiple instruction units, register files, GPGPU cores, and load store units, as illustrated in FIG. 14 and FIG. 15A. The execution resources 1556A-1556D can work in concert with texture unit(s) 1560A-1560D for texture operations, while sharing an instruction cache 1554, and shared memory 1553. For example, the execution resources 1556A-1556D can share an instruction cache 1554 and shared memory 1553, as well as multiple instances of a texture and/or data cache memory 1558A-1558B. The various components can communicate via an interconnect fabric 1552 similar to the interconnect fabric 1527 of FIG. 15A.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

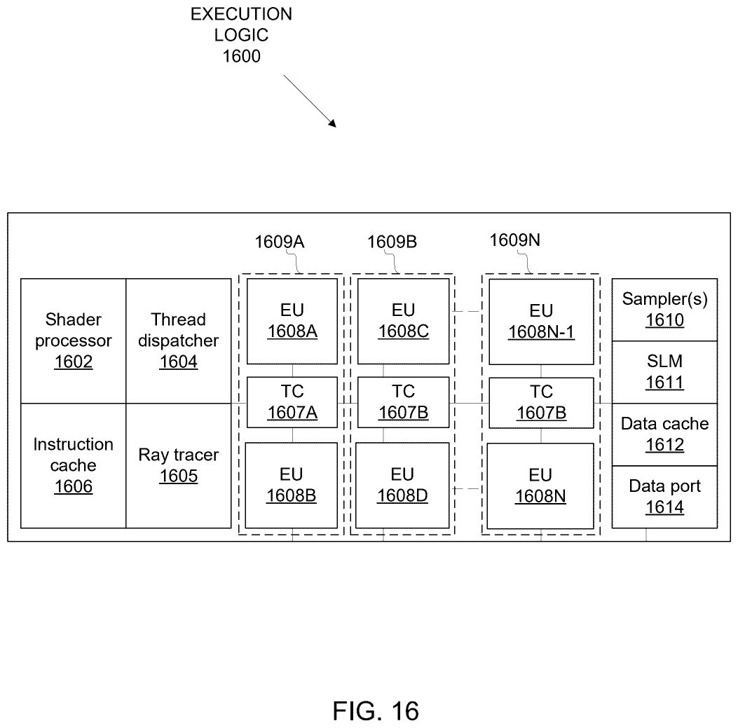

FIG. 16 illustrates thread execution logic 1600 including an array of processing elements employed in a graphics processor core according to examples described herein. FIG. 16 is representative of an execution unit within a general-purpose graphics processor.

As illustrated in FIG. 16, in some examples thread execution logic 1600 includes a shader processor 1602, a thread dispatcher 1604, instruction cache 1606, a scalable execution unit array including a plurality of execution units 1608A-1608N, a sampler 1610, shared local memory 1611, a data cache 1612, and a data port 1614. In some examples the scalable execution unit array can dynamically scale by enabling or disabling one or more execution units (e.g., any of execution units 1608A, 1608B, 1608C, 1608D, through 1608N-1 and 1608N) based on the computational requirements of a workload. In some examples the included components are interconnected via an interconnect fabric that links to each of the components. In some examples, thread execution logic 1600 includes one or more connections to memory, such as system memory or cache memory, through one or more of instruction cache 1606, data port 1614, sampler 1610, and execution units 1608A-1608N. In some examples, each execution unit (e.g. 1608A) is a stand-alone programmable general-purpose computational unit that is capable of executing multiple simultaneous hardware threads while processing multiple data elements in parallel for each thread. In various examples, the array of execution units 1608A-1608N is scalable to include any number individual execution units.

In some examples, the execution units 1608A-1608N are primarily used to execute shader programs. A shader processor 1602 can process the various shader programs and dispatch execution threads associated with the shader programs via a thread dispatcher 1604. In some examples the thread dispatcher includes logic to arbitrate thread initiation requests from the graphics and media pipelines and instantiate the requested threads on one or more execution unit in the execution units 1608A-1608N. For example, a geometry pipeline can dispatch vertex, tessellation, or geometry shaders to the thread execution logic for processing. In some examples, thread dispatcher 1604 can also process runtime thread spawning requests from the executing shader programs.

In some examples, the execution units 1608A-1608N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 1608A-1608N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 1608A-1608N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 1608A-1608N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 1608A-1608N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused graphics execution unit 1609A-1609N having thread control logic (1607A-1607N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 1609A-1609N includes at least two execution units. For example, fused execution unit 1609A includes a first EU 1608A, second EU 1608B, and thread control logic 1607A that is common to the first EU 1608A and the second EU 1608B. The thread control logic 1607A controls threads executed on the fused graphics execution unit 1609A, allowing each EU within the fused execution units 1609A-1609N to execute using a common instruction pointer register.

One or more internal instruction caches (e.g., 1606) are included in the thread execution logic 1600 to cache thread instructions for the execution units. In some examples, one or more data caches (e.g., 1612) are included to cache thread data during thread execution. Threads executing on the thread execution logic 1600 can also store explicitly managed data in the shared local memory 1611. In some examples, a sampler 1610 is included to provide texture sampling for 3D operations and media sampling for media operations. In some examples, sampler 1610 includes specialized texture or media sampling functionality to process texture or media data during the sampling process before providing the sampled data to an execution unit.

During execution, the graphics and media pipelines send thread initiation requests to thread execution logic 1600 via thread spawning and dispatch logic. Once a group of geometric objects has been processed and rasterized into pixel data, pixel processor logic (e.g., pixel shader logic, fragment shader logic, etc.) within the shader processor 1602 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 1602 then executes an application programming interface (API)-supplied pixel or fragment shader program. To execute the shader program, the shader processor 1602 dispatches threads to an execution unit (e.g., 1608A) via thread dispatcher 1604. In some examples, shader processor 1602 uses texture sampling logic in the sampler 1610 to access texture data in texture maps stored in memory. Arithmetic operations on the texture data and the input geometry data compute pixel color data for each geometric fragment, or discards one or more pixels from further processing.

In some examples, the data port 1614 provides a memory access mechanism for the thread execution logic 1600 to output processed data to memory for further processing on a graphics processor output pipeline. In some examples, the data port 1614 includes or couples to one or more cache memories (e.g., data cache 1612) to cache data for memory access via the data port.

In some examples, the execution logic 1600 can also include a ray tracer 1605 that can provide ray tracing acceleration functionality. The ray tracer 1605 can support a ray tracing instruction set that includes instructions/functions for ray generation.

In one or more first embodiments, an integrated circuit comprises a cache, a repository to provide information comprising unique identifiers each for a different respective one of multiple execution domains, and a search unit, coupled to the cache and the repository, comprising circuitry to perform a search of the cache based on each of an address from an access request and a unique identifier of an execution domain which corresponds to the access request, wherein the circuitry to perform the search comprises the circuitry to perform an evaluation of metadata which corresponds to a line of the cache, wherein the metadata indicates both a location in a memory, and a domain identifier value, based on the evaluation, generate a signal to indicate a failure of the search, wherein the failure is based on a condition in which the address corresponds to the location, and the unique identifier of the execution domain is different than the domain identifier value.

In one or more second embodiments, further to the first embodiment, the metadata, the line, the location, the domain identifier value, the signal, and the condition are, respectively, first metadata, a first line, a first location, a first domain identifier value, a first signal, and a first condition, second metadata which corresponds to a second line of the cache indicates both the first location, and a second domain identifier value, and the circuitry to perform the search further comprises the circuitry to perform a second evaluation of the second metadata, based on the second evaluation, generate a second signal to indicate a success of the search, wherein the second is based on a second condition in which the address corresponds to the location, and the unique identifier of the execution domain is the same as the second domain identifier value.

In one or more third embodiments, further to the first embodiment or the second embodiment, the circuitry is first circuitry, the access request is a request to write to a first page of the memory while the first page is mapped as a read-only page, and the integrated circuit further comprises second circuitry which, based on the access request, is to generate a second page of the memory, wherein the second page is a copy of the first page, and enable a privilege of the execution domain to access the second page.

In one or more fourth embodiments, further to the third embodiment, based on the access request, the second circuitry is further to disable a privilege of the execution domain to access the first page.

In one or more fifth embodiments, further to any of the first through third embodiments, the circuitry is to perform the search according to a first cache search mode of multiple cache search modes of a processor, the multiple cache search modes further comprise a second cache search mode, and a first criteria according to the first cache search mode comprises each parameter of a second criteria according to the second cache search mode, and further comprises a domain identifier parameter.

In one or more sixth embodiments, further to the fifth embodiment, the circuitry is further to perform an identification of a first page of the memory as being a target of the access request, based on the identification, access configuration state information which identifies a correspondence of the first page with the first cache search mode, and based on the configuration state information, select the first cache search mode from among the multiple cache search modes.

In one or more seventh embodiments, further to the sixth embodiment, an extended page table comprises the configuration state information.

In one or more eighth embodiments, further to the sixth embodiment, one or more address range registers comprise the configuration state information.

In one or more ninth embodiments, further to any of the first through third embodiments, the access request comprises a request to flush a line of the cache.

In one or more tenth embodiments, a system comprises a processor comprising a search unit comprising circuitry to perform a search of a cache based on each of an address from an access request and a unique identifier of an execution domain which corresponds to the access request, wherein the circuitry to perform the search comprises the circuitry to perform an evaluation of metadata which corresponds to a line of the cache, wherein the metadata indicates both a location in a memory, and a domain identifier value, based on the evaluation, generate a signal to indicate a failure of the search, wherein the failure is based on a condition in which the address corresponds to the location, and the unique identifier of the execution domain is different than the domain identifier value, and a memory controller coupled to the processor, wherein the memory controller is to be coupled between the processor and the memory.

In one or more eleventh embodiments, further to the tenth embodiment, the metadata, the line, the location, the domain identifier value, the signal, and the condition are, respectively, first metadata, a first line, a first location, a first domain identifier value, a first signal, and a first condition, second metadata which corresponds to a second line of the cache indicates both the first location, and a second domain identifier value, and the circuitry to perform the search further comprises the circuitry to perform a second evaluation of the second metadata, based on the second evaluation, generate a second signal to indicate a success of the search, wherein the second is based on a second condition in which the address corresponds to the location, and the unique identifier of the execution domain is the same as the second domain identifier value.

In one or more twelfth embodiments, further to the tenth embodiment or the eleventh embodiment, the circuitry is first circuitry, the access request is a request to write to a first page of the memory while the first page is mapped as a read-only page, and the processor further comprises second circuitry which, based on the access request, is to generate a second page of the memory, wherein the second page is a copy of the first page, and enable a privilege of the execution domain to access the second page.

In one or more thirteenth embodiments, further to the twelfth embodiment, based on the access request, the second circuitry is further to disable a privilege of the execution domain to access the first page.

In one or more fourteenth embodiments, further to any of the tenth through twelfth embodiments, the circuitry is to perform the search according to a first cache search mode of multiple cache search modes of a processor, the multiple cache search modes further comprise a second cache search mode, and a first criteria according to the first cache search mode comprises each parameter of a second criteria according to the second cache search mode, and further comprises a domain identifier parameter.

In one or more fifteenth embodiments, further to the fourteenth embodiment, the circuitry is further to perform an identification of a first page of the memory as being a target of the access request, based on the identification, access configuration state information which identifies a correspondence of the first page with the first cache search mode, and based on the configuration state information, select the first cache search mode from among the multiple cache search modes.

In one or more sixteenth embodiments, further to the fifteenth embodiment, an extended page table comprises the configuration state information.

In one or more seventeenth embodiments, further to the fifteenth embodiment, one or more address range registers comprise the configuration state information.

In one or more eighteenth embodiments, further to any of the tenth through twelfth embodiments, the access request comprises a request to flush a line of the cache.

In one or more nineteenth embodiments, a method comprises receiving an access request comprising an address, servicing the access request, comprising performing a search of a cache based on each of the address and a unique identifier of an execution domain which corresponds to the access request, wherein performing the search comprises performing an evaluation of metadata which corresponds to a line of the cache, wherein the metadata indicates both a location in a memory, and a domain identifier value, based on the evaluation, generating a signal to indicate a failure of the search, wherein the failure is based on a condition in which the address corresponds to the location, and the unique identifier of the execution domain is different than the domain identifier value.

In one or more twentieth embodiments, further to the nineteenth embodiment, the metadata, the line, the location, the domain identifier value, the signal, and the condition are, respectively, first metadata, a first line, a first location, a first domain identifier value, a first signal, and a first condition, second metadata which corresponds to a second line of the cache indicates both the first location, and a second domain identifier value, and performing the search further comprises performing a second evaluation of the second metadata, based on the second evaluation, generating a second signal to indicate a success of the search, wherein the second is based on a second condition in which the address corresponds to the location, and the unique identifier of the execution domain is the same as the second domain identifier value.

In one or more twenty-first embodiments, further to the nineteenth embodiment or the twentieth embodiment, the access request is a request to write to a first page of the memory while the first page is mapped as a read-only page, the method further comprises based on the access request generating a second page of the memory, wherein the second page is a copy of the first page, and enabling a privilege of the execution domain to access the second page.

In one or more twenty-second embodiments, further to the twenty-first embodiment, the method further comprises based on the access request, disabling a privilege of the execution domain to access the first page.

In one or more twenty-third embodiments, further to any of the nineteenth through twenty-first embodiments, the search is performed according to a first cache search mode of multiple cache search modes of a processor, the multiple cache search modes further comprise a second cache search mode, and a first criteria according to the first cache search mode comprises each parameter of a second criteria according to the second cache search mode, and further comprises a domain identifier parameter.

In one or more twenty-fourth embodiments, further to the twenty-third embodiment, the method further comprises performing an identification of a first page of the memory as being a target of the access request, based on the identification, accessing configuration state information which identifies a correspondence of the first page with the first cache search mode, and based on the configuration state information, selecting the first cache search mode from among the multiple cache search modes.

In one or more twenty-fifth embodiments, further to the twenty-fourth embodiment, an extended page table comprises the configuration state information.

In one or more twenty-sixth embodiments, further to the twenty-fourth embodiment, one or more address range registers comprise the configuration state information.

In one or more twenty-seventh embodiments, further to any of the nineteenth through twenty-first embodiments, the access request comprises a request to flush a line of the cache.

In one or more twenty-eighth embodiments, one or more non-transitory computer-readable storage media have stored thereon instructions which, when executed by one or more processing units, cause the one or more processing units to perform a method comprising accessing a repository of configuration state information to specify a correspondence of a first page of a memory with a first cache search mode, and accessing the repository of configuration state information to specify a correspondence of a second page of the memory with a second cache search mode, wherein a first cache search criteria according to the first cache search mode comprises each cache search criteria according to the second cache search mode, and further comprises a domain identifier parameter, and a second cache search criteria according to the second cache search mode comprises an address parameter.

In one or more twenty-ninth embodiments, a method comprises accessing a repository of configuration state information to specify a correspondence of a first page of a memory with a first cache search mode, and accessing the repository of configuration state information to specify a correspondence of a second page of the memory with a second cache search mode, wherein a first cache search criteria according to the first cache search mode comprises each cache search criteria according to the second cache search mode, and further comprises a domain identifier parameter, and a second cache search criteria according to the second cache search mode comprises an address parameter.

Techniques and architectures for searching a cache are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit comprising:
a cache;
a repository to provide information comprising unique identifiers each for a different respective one of multiple execution domains; and
a search unit, coupled to the cache and the repository, comprising circuitry to:
perform a search of the cache based on each of an address from an access request and a unique identifier of an execution domain which corresponds to the access request, wherein the circuitry to perform the search comprises the circuitry to:
perform an evaluation of metadata which corresponds to a line of the cache, wherein the metadata indicates both a location in a memory, and a domain identifier value;
based on the evaluation, generate a signal to indicate a failure of the search, wherein the failure is based on a condition in which:
the address corresponds to the location; and
the unique identifier of the execution domain is different than the domain identifier value.

2. The integrated circuit of claim 1, wherein:
the metadata, the line, the location, the domain identifier value, the signal, and the condition are, respectively, first metadata, a first line, a first location, a first domain identifier value, a first signal, and a first condition;
second metadata which corresponds to a second line of the cache indicates both the first location, and a second domain identifier value; and
the circuitry to perform the search further comprises the circuitry to:
perform a second evaluation of the second metadata;
based on the second evaluation, generate a second signal to indicate a success of the search, wherein the second is based on a second condition in which:
the address corresponds to the location; and
the unique identifier of the execution domain is the same as the second domain identifier value.

3. The integrated circuit of claim 1, wherein:
the circuitry is first circuitry;
the access request is a request to write to a first page of the memory while the first page is mapped as a read-only page; and
the integrated circuit further comprises second circuitry which, based on the access request, is to:
generate a second page of the memory, wherein the second page is a copy of the first page; and
enable a privilege of the execution domain to access the second page.

4. The integrated circuit of claim 3, wherein, based on the access request, the second circuitry is further to disable a privilege of the execution domain to access the first page.

5. The integrated circuit of claim 1, wherein:
the circuitry is to perform the search according to a first cache search mode of multiple cache search modes of a processor;
the multiple cache search modes further comprise a second cache search mode; and
a first criteria according to the first cache search mode comprises each parameter of a second criteria according to the second cache search mode, and further comprises a domain identifier parameter.

6. The integrated circuit of claim 5, wherein the circuitry is further to:
perform an identification of a first page of the memory as being a target of the access request;
based on the identification, access configuration state information which identifies a correspondence of the first page with the first cache search mode; and
based on the configuration state information, select the first cache search mode from among the multiple cache search modes.

7. The integrated circuit of claim 6, wherein an extended page table comprises the configuration state information.

8. The integrated circuit of claim 6, wherein one or more address range registers comprise the configuration state information.

9. The integrated circuit of claim 1, wherein the access request comprises a request to flush a line of the cache.

10. A system comprising:
a processor comprising:
a search unit comprising circuitry to perform a search of a cache based on each of an address from an access request and a unique identifier of an execution domain which corresponds to the access request, wherein the circuitry to perform the search comprises the circuitry to:
perform an evaluation of metadata which corresponds to a line of the cache, wherein the metadata indicates both a location in a memory, and a domain identifier value;
based on the evaluation, generate a signal to indicate a failure of the search, wherein the failure is based on a condition in which:
the address corresponds to the location; and
the unique identifier of the execution domain is different than the domain identifier value; and
a memory controller coupled to the processor, wherein the memory controller is to be coupled between the processor and the memory.

11. The system of claim 10, wherein:
the metadata, the line, the location, the domain identifier value, the signal, and the condition are, respectively, first metadata, a first line, a first location, a first domain identifier value, a first signal, and a first condition;
second metadata which corresponds to a second line of the cache indicates both the first location, and a second domain identifier value; and
the circuitry to perform the search further comprises the circuitry to:
perform a second evaluation of the second metadata;
based on the second evaluation, generate a second signal to indicate a success of the search, wherein the second is based on a second condition in which:
the address corresponds to the location; and
the unique identifier of the execution domain is the same as the second domain identifier value.

12. The system of claim 10, wherein:
the circuitry is first circuitry;
the access request is a request to write to a first page of the memory while the first page is mapped as a read-only page; and
the processor further comprises second circuitry which, based on the access request, is to:
generate a second page of the memory, wherein the second page is a copy of the first page; and
enable a privilege of the execution domain to access the second page.

13. The system of claim 10, wherein:
the circuitry is to perform the search according to a first cache search mode of multiple cache search modes of a processor;
the multiple cache search modes further comprise a second cache search mode; and
a first criteria according to the first cache search mode comprises each parameter of a second criteria according to the second cache search mode, and further comprises a domain identifier parameter.

14. The system of claim 13, wherein the circuitry is further to:
perform an identification of a first page of the memory as being a target of the access request;
based on the identification, access configuration state information which identifies a correspondence of the first page with the first cache search mode; and
based on the configuration state information, select the first cache search mode from among the multiple cache search modes.

15. The system of claim 14, wherein an extended page table comprises the configuration state information.

16. The system of claim 10, wherein the access request comprises a request to flush a line of the cache.

17. A method comprising:
receiving an access request comprising an address;
servicing the access request, comprising:
performing a search of a cache based on each of the address and a unique identifier of an execution domain which corresponds to the access request, wherein performing the search comprises:
performing an evaluation of metadata which corresponds to a line of the cache, wherein the metadata indicates both a location in a memory, and a domain identifier value;
based on the evaluation, generating a signal to indicate a failure of the search, wherein the failure is based on a condition in which:
the address corresponds to the location; and
the unique identifier of the execution domain is different than the domain identifier value.

18. The method of claim 17, wherein:
the metadata, the line, the location, the domain identifier value, the signal, and the condition are, respectively, first metadata, a first line, a first location, a first domain identifier value, a first signal, and a first condition;
second metadata which corresponds to a second line of the cache indicates both the first location, and a second domain identifier value; and
performing the search further comprises:
performing a second evaluation of the second metadata;
based on the second evaluation, generating a second signal to indicate a success of the search, wherein the second is based on a second condition in which:
the address corresponds to the location; and
the unique identifier of the execution domain is the same as the second domain identifier value.

19. The method of claim 17, wherein:
the search is performed according to a first cache search mode of multiple cache search modes of a processor;
the multiple cache search modes further comprise a second cache search mode; and
a first criteria according to the first cache search mode comprises each parameter of a second criteria according to the second cache search mode, and further comprises a domain identifier parameter.

20. The method of claim 19, further comprising:
performing an identification of a first page of the memory as being a target of the access request;
based on the identification, accessing configuration state information which identifies a correspondence of the first page with the first cache search mode; and
based on the configuration state information, selecting the first cache search mode from among the multiple cache search modes.
